(19) United States
(12) Patent Application Publication
(10) Pub. No.: US 2021/0129566 A1
(43) Pub. Date: May 6, 2021

(54) PRINTED MATTER PRODUCING METHOD, PRINTED MATTER PRODUCING APPARATUS, AND PRINTED MATTER

(71) Applicants: Yuuma USUI, Kanagawa (JP); Masakazu YOSHIDA, Kanagawa (JP); Yukio FUJIWARA, Kanagawa (JP); Mikiko TAKADA, Kanagawa (JP)

(72) Inventors: Yuuma USUI, Kanagawa (JP); Masakazu YOSHIDA, Kanagawa (JP); Yukio FUJIWARA, Kanagawa (JP); Mikiko TAKADA, Kanagawa (JP)

(21) Appl. No.: 17/068,941

(22) Filed: Oct. 13, 2020

(30) Foreign Application Priority Data
Oct. 30, 2019 (JP) 2019-197393
Aug. 25, 2020 (JP) 2020-141631

(51) Int. Cl. B41M 5/00; B41M 5/50; B41M 7/00

(52) U.S. Cl. CPC B41M 5/0017; B41M 5/508; B41M 7/0036; B41M 5/0064; B41M 5/0047

(57) ABSTRACT

Provided is a printed matter producing method including: a foamable layer forming step of forming a foamable layer containing a foaming agent, an ink receiving layer forming step of forming an ink receiving layer containing a polymer of a polymerizable compound a over the foamable layer, an image forming step of applying an ink containing a colorant and a polymerizable compound b over the ink receiving layer to form an image, and a foaming step of heating the foamable layer to foam the foamable layer.

### CROSS-REFERENCE TO RELATED APPLICATIONS

This patent application is based on and claims priority pursuant to 35 U.S.C. § 119(a) to Japanese Patent Application Nos. 2019-197393 and 2020-141631, filed on Oct. 30, 2019 and Aug. 25, 2020, respectively, in the Japan Patent Office, the entire disclosure of each of which is hereby incorporated by reference herein.

### BACKGROUND

### Technical Field

The present disclosure relates to a printed matter producing method, a printed matter producing apparatus, and a printed matter.

### Description of the Related Art

Materials such as floorings and wallpaper having desired images printed and design properties imparted by, for example, embossing have been used on, for example, floors, interior walls, and ceilings of buildings. Attempts have been made to improve durability of floorings and wallpaper through, for example, coating with ultraviolet (UV)-curable materials and coating with electron beam-curable materials.

Moreover, in recent years, techniques for inkjet-printing desired images on, for example, embossed floorings and wallpaper have been being developed. A method proposed as such a technique produces foamable wallpaper including a foamable layer, an image forming layer, and a surface protecting layer, wherein the foamable layer contains a thermoplastic resin and a foaming agent, and wherein the image forming layer and the surface protecting layer are crosslinkable or curable by electron beam irradiation.

### SUMMARY

According to an aspect of the present disclosure, a printed matter producing method includes a foamable layer forming step of forming a foamable layer containing a foaming agent, an ink receiving layer forming step of forming an ink receiving layer containing a polymer of a polymerizable compound a over the foamable layer, an image forming step of applying an ink containing a colorant and a polymerizable compound b over the ink receiving layer to form an image, and a foaming step of heating the foamable layer to foam the foamable layer.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating a printed matter producing apparatus according to an embodiment of the present disclosure;

FIG. 2 is a schematic view illustrating another example of a printed matter producing apparatus according to an embodiment of the present disclosure;

FIG. 3A is an exemplary view illustrating an example of a flow of printed matter production in a printed matter producing method according to an embodiment of the present disclosure;

FIG. 3B is an exemplary view illustrating an example of a flow of printed matter production in a printed matter producing method according to an embodiment of the present disclosure;

FIG. 3C is an exemplary view illustrating an example of a flow of printed matter production in a printed matter producing method according to an embodiment of the present disclosure;

FIG. 3D is an exemplary view illustrating an example of a flow of printed matter production in a printed matter producing method according to an embodiment of the present disclosure;

FIG. 3E is an exemplary view illustrating an example of a flow of printed matter production in a printed matter producing method according to an embodiment of the present disclosure;

FIG. 3F is an exemplary view illustrating an example of a flow of printed matter production in a printed matter producing method according to an embodiment of the present disclosure; and

FIG. 3G is an exemplary view illustrating an example of a flow of printed matter production in a printed matter producing method according to an embodiment of the present disclosure.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide a printed matter producing method capable of producing a printed matter that has an excellent design property based on a bossed-recessed shape and an excellent image quality and can maintain the excellent design property based on the bossed-recessed shape and the excellent image quality for a long term.

### (Printed Matter Producing Method and Printed Matter Producing Apparatus)

A printed matter producing method of the present disclosure includes a foamable layer forming step of forming a foamable layer containing a foaming agent, an ink receiving layer forming step of forming an ink receiving layer containing a polymer of a polymerizable compound a over the foamable layer, an image forming step of applying an ink containing a colorant and a polymerizable compound b over the ink receiving layer to form an image, and a foaming step of heating the foamable layer to foam the foamable layer, preferably includes at least one of a transparent layer forming step, a defoaming agent applying step, a base material surface reforming step, a foamable layer surface reforming step, a filler-containing layer forming step, and an adhesive layer forming step, and further includes other steps as needed.

A printed matter producing apparatus of the present disclosure includes a foamable layer forming unit configured to form a foamable layer containing a foaming agent, an ink receiving layer forming unit configured to form an ink receiving layer containing a polymer of a polymerizable compound a over the foamable layer, an image forming unit configured to apply an ink containing a colorant and a polymerizable compound b over the ink receiving layer to form an image, and a foaming unit configured to heat the foamable layer to foam the foamable layer, preferably includes at least one of a transparent layer forming unit, a defoaming agent applying unit, a base material surface reforming unit, a foamable layer surface reforming unit, a filler-containing layer forming unit, and an adhesive layer forming unit, and further includes other units as needed.

The printed matter producing method of the present disclosure can be suitably performed by the printed matter producing apparatus of the present disclosure. The foamable layer forming step can be suitably performed by the foamable layer forming unit. The ink receiving layer forming step can be suitably performed by the ink receiving layer forming unit. The image forming step can be suitably performed by the image forming unit. The foaming step can be suitably performed by the foaming unit. The transparent layer forming step can be suitably performed by the transparent layer forming unit. The defoaming agent applying step can be suitably performed by the defoaming agent applying unit. The base material surface reforming step can be suitably performed by the base material surface reforming unit. The foamable layer surface reforming step can be suitably performed by the foamable layer surface reforming unit. The filler-containing layer forming step can be suitably performed by the filler-containing layer forming unit. The adhesive layer forming step can be suitably performed by the adhesive layer forming unit. The other steps can be performed by the other units.

The printed matter producing method of the present disclosure is based on the present inventors' finding that existing printed matter producing methods may not be able to impart an adequate bossed-recessed shape to a printed matter, and may not be able to impart an adequate design property based on a bossed-recessed shape and adequate qualities (color developability and durability) to an image formed over bosses and recesses.

Existing printed matter producing methods need embossing by a mold in order to impart a bossed-recessed shape, making small-lot production difficult and production costs high. Moreover, existing printed matter producing methods are not able to sufficiently develop colors of an image formed on the bosses and recesses of a bossed-recessed shape formed by foaming a foamable layer, leading to density unevenness. In addition, existing printed matter producing methods are not able to impart an adequate durability to an image formed over a foamable layer having a bossed-recessed shape formed by foaming the foamable layer, leading to problems such as generation of scars on the image due to, for example, external shocks, and peeling of the image from the foamable layer.

Hence, the present inventors have conducted earnest studies into, for example, a printed matter producing method capable of producing a printed matter that has an excellent design property based on a bossed-recessed shape and an excellent image quality and can maintain the excellent design property based on the bossed-recessed shape and the excellent image quality for a long term, and conceived of the present disclosure. That is, the present inventors have found that a printed matter that has an excellent design property based on a bossed-recessed shape and an excellent image quality and can maintain the excellent design property based on the bossed-recessed shape and the excellent image quality for a long term can be produced by a printed matter producing method including a foamable layer forming step of forming a foamable layer containing a foaming agent, an ink receiving layer forming step of forming an ink receiving layer containing a polymer of a polymerizable compound a over the foamable layer, an image forming step of applying an ink containing a colorant and a polymerizable compound b over the ink receiving layer to form an image, and a foaming step of heating the foamable layer to foam the foamable layer.

The printed matter producing method of the present disclosure forms an ink receiving layer containing a polymer of a polymerizable compound a over a foamable layer, and applies an ink containing a colorant and a polymerizable compound b over the ink receiving layer to form an image. In this way, the printed matter producing method of the present disclosure can provide a high affinity between the ink receiving layer and the ink because the materials of the ink receiving layer and the ink both contain polymerizable compounds. Therefore, by forming an image by application of an ink over the ink receiving layer, the printed matter producing method of the present disclosure can improve color developability of the image formed with the ink and improve durability of the image against, for example, external shocks.

Moreover, the printed matter producing method of the present disclosure forms a foamable layer containing a foaming agent and foams the foamable layer. In this way, the printed matter producing method of the present disclosure can easily impart an excellent design property based on a bossed-recessed shape to a printed matter.

Hence, the printed matter producing method of the present disclosure including the foamable layer forming step, the ink receiving layer forming step, the image forming step, and the foaming step can produce a printed matter that has an excellent design property based on a bossed-recessed shape and an excellent image quality and can maintain the excellent design property based on the bossed-recessed shape and the excellent image quality for a long term.

### <Foamable Layer Forming Step and Foamable Layer Forming Unit>

The foamable layer forming step is a step of forming a foamable layer containing a foaming agent.

The foamable layer forming unit is a unit configured to form a foamable layer containing a foaming agent.

The foamable layer forming unit is not particularly limited and may be appropriately selected depending on the intended purpose. Examples of the foamable layer forming unit include, but are not limited to, combination of a known material applying unit (e.g., a coating unit and a discharging unit) and a known energy applying unit (e.g., a thermal energy applying unit and an active energy ray irradiation unit).

The foamable layer forming step is not particularly limited so long as a foamable layer can be formed. For example, it is preferable that the material applying unit apply a foamable layer forming liquid containing a foaming agent over a base material to form a film, and then the energy applying unit cure the film to form a foamable layer. In other words, in the foamable layer forming step, it is preferable to form a foamable layer by applying a foamable layer forming liquid containing a foaming agent over a base material and then curing the foamable layer forming liquid.

The timing at which the foamable layer forming liquid is cured is not particularly limited and may be appropriately selected depending on the intended purpose. For example, the foamable layer may be collectively cured with at least one of an ink receiving layer described below and an ink that forms an image, when curing the ink receiving layer and the ink that forms an image.

### <<Base Material>>

The base material over which the foamable layer forming liquid is applied is not particularly limited and may be appropriately selected depending on the intended purpose. Examples of the base material include, but are not limited to, resin films, sheets such as resin-impregnated paper, synthetic paper formed of synthetic fiber, natural paper, and nonwoven fabric, cloths, wooden boards, metallic plates, glass plates, ceramic plates, and building materials.

Examples of the resin films include, but are not limited to, polyester films, polypropylene films, polyethylene films, plastic films of nylon, vinylon, and acrylic, and pasted products of these films.

In terms of strength, uniaxially or biaxially stretched resin films are preferable.

The nonwoven fabric is not particularly limited and may be appropriately selected depending on the intended purpose. Examples of the nonwoven fabric include, but are not limited to, nonwoven fabric formed of polyethylene fibers sprinkled in a sheet shape and thermocompression-bonded with each other to obtain a sheet shape.

The wooden board is not particularly limited and may be appropriately selected depending on the intended purpose. Examples of the wooden board include, but are not limited to, plywoods such as MDF, HDF, particle boards, and veneers, and decorative laminates having pasted sheets over the surfaces. The thickness of the wooden board may be, for example, from 2 mm through 30 mm.

The glass plate is not particularly limited and may be appropriately selected depending on the intended purpose. Examples of the glass plate include, but are not limited to, float glass, colored glass, tempered glass, wire glass, ground glass, frosted glass, and mirror glass. The thickness of the glass plate may be, for example, from 0.3 mm through 20 mm.

The building material is not particularly limited and may be appropriately selected depending on the intended purpose. Examples of the building material include, but are not limited to, thermosetting resins, fiber boards, and particle boards used for, for example, flooring materials, wallpaper, interior materials, wall plate materials, baseboards, ceiling materials, and pillars, and decorative laminates of, for example, thermosetting resins, olefins, polyester, and PVC provided on the surfaces of the materials mentioned above.

### <<Foamable Layer Forming Liquid>>

The foamable layer forming liquid contains a foaming agent, preferably contains a liquid composition, and further contains other components as needed.

### —Foaming Agent—

The foaming agent is not particularly limited and may be appropriately selected depending on the intended purpose so long as the foaming agent is a material that volume-expands when heated. Examples of the foaming agent include, but are not limited to, thermally expansible microcapsules, and thermally degradable foaming agents. Among these foaming agents, thermally expansible microcapsules are preferable because thermally expansible microcapsules have a high coefficient of thermal expansion and can form uniform, small independent cells. In the following description, the foaming agent may be referred to as volume expansion agent.

A thermally expansible microcapsule is a particle having a core-shell structure encapsulating a foaming agent with a thermoplastic resin. In response to heating, the thermoplastic resin constituting the outer shell starts to soften, and the vapor pressure of the encapsulated foamable compound rises to a pressure enough to deform the particle. As a result, the thermoplastic resin constituting the outer shell is drawn and expands the particle. Examples of the foamable compound include, but are not limited to, aliphatic hydrocarbons having low boiling points.

A commercially available product can be used as the thermally expansible microcapsule. Examples of the commercially available product include, but are not limited to, ADVANCELL EM SERIES available from Sekisui Chemical Co., Ltd., EXPANCELL DU, WU, MB, SL, and FG SERIES available from Akzo Nobel N.V. (sold by Japan Fillite Co., Ltd. in Japan), MATSUMOTO MICROSPHERE F and FN SERIES available from Matsumoto Yushi-Seiyaku Co., Ltd., and KUREHA MICROSPHERE H750, H850, and H1100 available from KUREHA Corporation. One of these commercially available products may be used alone or two or more of these commercially available products may be used in combination.

Examples of the thermally degradable foaming agent include, but are not limited to, organic foaming agents and inorganic foaming agents.

Examples of the organic foaming agent include, but are not limited to, azodicarboxylic acid amide (ADCA), azobisisobutyronitrile (AIBN), p,p′-oxybisbenzenesulfonyl hydrazide (OBSH), and dinitrosopentamethylene tetramine (DPT). One of these organic foaming agents may be used alone or two or more of these organic foaming agents may be used in combination.

Examples of the inorganic foaming agent include, but are not limited to, bicarbonates such as sodium hydrogen carbonate, carbonates, and combinations of bicarbonates and organic acid salts.

The content of the foaming agent in the curable composition is not particularly limited, may be appropriately selected depending on the intended purpose, and is preferably 1% by mass or greater but 20% by mass or less and more preferably 5% by mass or greater but 15% by mass or less relative to the total amount of the curable composition.

### —Liquid Composition—

The liquid composition is not particularly limited and may be appropriately selected depending on the intended purpose. Examples of the liquid composition include, but are not limited to, water, water-based organic solvents, oil-based organic solvents, and polymerizable solvents. The liquid composition may be selected depending on, for example, a liquid contact property with respect to the foaming agent (i.e., whether the liquid composition inhibits the foaming function by, for example, permeating the foaming agent). As the reference of the liquid contact property of the liquid composition, a SP value (solubility parameter) can be used. For example, it is preferable to select a liquid that has a SP value apart from the SP value of the foaming agent in order not to be compatibilized with the foaming agent.

The liquid composition serves as a dispersion medium of the foaming agent. When the liquid composition is a polymerizable solvent (polymerizable compound), the liquid composition can also serve as a constituent of the foamable layer. When the liquid composition is a liquid that is not a polymerizable solvent, it is preferable to further add a resin to the liquid composition so that the liquid composition can serve as a constituent of the foamable layer.

Examples of the water-based organic solvent include, but are not limited to, polyvalent alcohols such as methanol, ethanol, 1-propanol, 2-propanol, ethylene glycol, diethylene glycol, triethylene glycol, tetraethylene glycol, polyethylene glycol, propylene glycol, 1,3-propanediol, 2-methyl-1,3-propanediol, 1,4-butanediol, 1,5-pentanediol, 1,6-hexanediol, glycerin, 1,2,6-hexanetriol, 2-ethyl-1,3-hexanediol, 1,2,4-butanetriol, 1,2,3-butanetriol, and petriol; polyvalent alcohol alkylethers such as ethylene glycol monoethylether, ethylene glycol monobutylether, diethylene glycol monomethylether, diethylene glycol monoethylether, diethylene glycol monobutylether, triethylene glycol monobutylether, tetraethylene glycol monomethylether, and propylene glycol monoethylether; polyvalent alcohol arylethers such as ethylene glycol monophenylether and ethylene glycol monobenzylether; nitrogen-containing heterocyclic compounds such as N-methyl-2-pyrrolidone, N-hydroxyethyl-2-pyrrolidone, 2-pyrrolidone, 1,3-dimethyl imidazolidinone, and ε-caprolactam; amides such as formamide, N-methylformamide, and N,N-dimethylformamide; amines such as monoethanolamine, diethanolamine, triethanolamine, monoethylamine, diethylamine, and triethylamine; sulfur-containing compounds such as diemthylsulfoxide, sulfolane, and thiodiethanol; propylene carbonate; ethylene carbonate; γ-butyrolactone; and acetone.

Examples of the oil-based organic solvent when it is hydrocarbon include, but are not limited to dodecane, isododecane, hexadecane, isohexadecane, liquid paraffin, squalane, squalene, polybutene, polyisobutylene, cyclopentane, cyclohexane, polybutadiene, hydrogenated polybutadiene, polyisoprene, and hydrogenated polyisoprene.

Examples of the oil-based organic solvent when it is ester oil include, but are not limited to, isopropyl myristate, isopropyl palmitate, cetyl octanate, octyl dodecyl myristate, butyl stearate, hexyl laurate, myristyl myristate, decyl oleate, hexyl decyl dimethyloctanate, cetyl lactate, lanolin acetate, isocetyl stearate, isocetyl isostearate, di-2-ethylhexyl sebacate, di-2-hexyldecyl myristate, di-2-hexyldecyl palmitate, di-2-hexyldecyl adipate, and diisopropyl sebacate.

Examples of the oil-based organic solvent when it is higher fatty acid include, but are not limited to, isostearic acid, oleic acid, palmitic acid, lauric acid, myristic acid, behenic acid, linoleic acid, and linolenic acid. For example, oleic acid that is liquid at normal temperature is particularly preferable. Examples of the oil-based organic solvent when it is higher alcohol include but are not limited to, isostearyl alcohol, oleyl alcohol, octyl dodecanol chloesterol, stearyl alcohol, cetyl alcohol, decyl tetradecanol, hexyl decanol, behenyl alcohol, lauryl alcohol, lanolin alcohol, myristyl alcohol, and batyl alcohol. For example, oleyl alcohol that is liquid at normal temperature is particularly preferable.

Examples of the oil-based organic solvent when it is silicone include, but are not limited to, dimethyl polysiloxane, cyclomethicone, diphenyl polysiloxane, alkyl polysiloxane. Other examples of the oil-based organic solvent include, but are not limited to, compounds other than water-based organic solvents, such as methyl acetate, ethyl acetate, propyl acetate, butyl acetate, ethyl lactate, ethyl ethoxypropionate, butanol, normal hexane, cyclohexane methyl ethyl ketone, methyl isobutyl ketone, cyclohexanone, tetrahydrofuran, dioxane, toluene, ethyl benzene, acetophenone, and benzyl alcohol.

### —Polymerizable Solvent (Polymerizable Compound)—

The polymerizable solvent (polymerizable compound) is not particularly limited and may be appropriately selected depending on the intended purpose so long as the polymerizable solvent is a compound that can be polymerized when energy is applied. Examples of the polymerizable solvent include, but are not limited to, monofunctional monomers, multifunctional monomers, and combinations of monofunctional monomers and multifunctional monomers.

### —Monofunctional Monomer—

A monofunctional monomer contains, for example, one vinyl group, one acryloyl group, or one methacryloyl group in a molecular structure thereof.

Examples of the monofunctional monomer include, but are not limited to, γ-butyrolactone (meth)acrylate, isobornyl (meth)acrylate, formalized trimethylolpropane mono(meth)acrylate, trimethylolpropane (meth)acrylic acid benzoic acid ester, (meth)acryloylmorpholine, 2-hydroxylpropyl (meth)acrylamide, N-vinyl caprolactam, N-vinyl pyrrolidone, N-vinyl formamide, cyclohexane dimethanol monovinyl ether, hydroxyethyl vinyl ether, diethylene glycol monovinyl ether, dicyclopentadiene vinyl ether, tricyclodecane vinyl ether, benzyl vinyl ether, ethyloxetane vinyl ether, hydroxybutyl vinyl ether, ethylvinyl ether, ethoxy(4)nonylphenol (meth)acrylate, benzyl (meth)acrylate, and caprolactone (meth)acrylate. One of these monofunctional monomers may be used alone or two or more of these monofunctional monomers may be used in combination.

Among these monofunctional monomers, isobornyl (meth)acrylate is preferable because isobornyl (meth)acrylate has a high glass transition temperature (Tg) and a good robutsness.

The content of the monofunctional monomer is preferably 80% by mass or greater but 99.5% by mass or less and more preferably 90% by mass or greater but 95% by mass or less relative to the total amount of the curable composition.

### —Multifunctional Monomer—

A multifunctional monomer is a compound that contains, for example, two or more vinyl groups, two or more acryloyl groups, or two or more methacryloyl groups in a molecular structure thereof.

Examples of the multifunctional monomer include, but are not limited to, ethylene glycol di(meth)acrylate, hydroxypivalic acid neopentyl glycol di(meth)acrylate, polytetramethylene glycol di(meth)acrylate, diethylene glycol di(meth)acrylate, triethylene glycol di(meth)acrylate, tetraethylene glycol di(meth)acrylate, polyethylene glycol dimethacrylate [CH₂═CH—CO—(OC₂H₄)ₙ—OCOCH═CH₂ (n≈9), the same (n≈14), and the same (n≈23)], dipropylene glycol di(meth)acrylate, tripropylene glycol di(meth)acrylate, polypropylene glycol dimethacrylate [CH₂═C(CH₃)—CO—(OC₃H₆)ₙ—OCOC(CH₃)═CH₂ (n≈7)], 1,3-butanediol di(meth)acrylate, 1,4-butanediol di(meth)acrylate, 1,6-hexanediol di(meth)acrylate, 1,9-nonanediol di(meth)acrylate, neopentyl glycol di(meth)acrylate, tricyclodecane dimethanol di(meth)acrylate, propylene oxide-modified bisphenol A di(meth)acrylate, polyethylene glycol di(meth)acrylate, dipentaerythritol hexa(meth)acrylate, propylene oxide-modified tetramethylolmethane tetra(meth)acrylate, dipentaerythritol hydroxypenta(meth)acrylate, caprolactone-modified dipentaerythritol hydroxypenta(meth)acrylate, ditrimethylolpropane tetra(meth)acrylate, pentaerythritol tetra(meth)acrylate, trimethylolpropane tri(meth)acrylate, ethylene oxide-modified trimethylolpropane tri(meth)acrylate, propylene oxide-modified trimethylolpropane tri(meth)acrylate, caprolactone-modified trimethylolpropane tri(meth)acrylate, pentaerythritol tri(meth)acrylate, tris(2-hydroxyethyl)isocyanurate tri(meth)acrylate, ethoxylated neopentyl glycol di(meth)acrylate, propylene oxide-modified neopentyl glycol di(meth)acrylate, propylene oxide-modified glyceryl tri(meth)acrylate, polyester di(meth)acrylate, polyester tri(meth)acrylate, polyester tetra(meth)acrylate, polyester penta(meth)acrylate, polyester poly(meth)acrylate, polyurethane di(meth)acrylate, polyurethane tri(meth)acrylate, polyurethane tetra(meth)acrylate, polyurethane penta(meth)acrylate, polyurethane poly(meth)acrylate, triethylene glycol divinyl ether, cyclohexane dimethanol divinyl ether, diethylene glycol divinyl ether, triethylene glycol divinyl ether, and ethoxylated (4)bisphenol di(meth)acrylate. One of these multifunctional monomers may be used alone or two or more of these multifunctional monomers may be used in combination.

The [molecular weight] of the multifunctional monomer or the [number of functional groups] in the multifunctional monomer is preferably, for example, 250 or greater, because a design property (volume expansibility) and robustness can both be satisfied.

The content of multifunctional monomers and oligomers in the polymerizable compound is preferably 0.5% by mass or greater but 20% by mass or less and more preferably 5% by mass or greater but 10% by mass or less relative to the total amount of the polymerizable compound. When the content of multifunctional monomers and oligomers is 10% by mass or less, there is an advantage that a design property (foamability) and robustness can both be satisfied.

The content of the polymerizable compound is not particularly limited, may be appropriately selected depending on the intended purpose, and is preferably 60% by mass or greater but 90% by mass or less and more preferably 70% by mass or greater but 85% by mass or less relative to the total amount of the volume expansion layer forming liquid. When the content of the polymerizable compound is 70% by mass or less, the foaming agent in the foamable layer can have an enhanced adhesiveness.

### —Other Components—

Other components in the foamable layer forming liquid is not particularly limited and may be appropriately selected depending on the intended purpose. Examples of the other components include, but are not limited to, a binder resin, a polymerization initiator, a filler, a foaming accelerator, a dispersant, a colorant, an organic solvent, an antiblocking agent, a thickener, a preservative, a stabilizer, a deodorant, a fluorescent agent, an ultraviolet screener, and a surfactant. Among these components, it is preferable to add a polymerization initiator when the liquid composition is a polymerizable solvent (polymerizable compound). It is preferable to add a binder resin when, for example, the liquid composition is not a polymerizable compound.

### —Binder Resin—

The binder resin is not particularly limited and may be appropriately selected depending on the intended purpose so long as the binder resin can support the foaming agent. Examples of the binder resin include, but are not limited to, water-soluble resins, emulsion resins, and other resins.

Examples of the water-soluble resin when it is of natural origin include, but are not limited to, vegetable polymers such as gum Arabic, gum tragacanth, guar gum, Karaya gum, locust bean gum, arabinogalactan, pectin, quince seed, and starch; seaweed polymers such as alginic acid, carrageenan, and agar; animal polymers such as gelatin, casein, albumin, and collagen; microbial polymers such as xanthan gum, and dextran or shellac. Examples of the water-soluble resin when it is semisynthetic include, but are not limited to, cellulose polymers such as methyl cellulose, ethyl cellulose, hydroxyethyl cellulose, hydroxypropyl cellulose, and carboxymethyl cellulose; starch polymers such as sodium starch glycolate and starch phosphoric acid ester sodium, and seewead polymers such as sodium alginate and alginic acid propylene glycol ester. Examples of the water-soluble resin when it is purely synthetic include, but are not limited to, vinyl-based polymers such as polyvinyl alcohol, polyvinyl pyrrolidone, and polyvinyl methyl ether; uncrosslinked polyacrylamide; polyacrylic acid and alkali metal salts of polyacrylic acid; acrylic-based resins such as water-soluble styrene-acrylic resins; water-soluble styrene-maleic acid resins; water-soluble vinyl naphthalene-acrylic resins; water-soluble vinyl naphthalene-maleic acid resins; and alkali metal salts of β naphthalene sulfonic acid formalin condensate.

Examples of the emulsion resin include, but are not limited to, acrylic-based resins, vinyl acetate-based resins, styrene-butadiene-based resins, vinyl chloride-based resins, acrylic-styrene-based resins, butadiene-based resins, and styrene-based resins.

Examples of other resins that can be used as the binder resin include, but are not limited to, polyester resins and acrylic resins that are soluble in oil-based organic solvents.

### —Polymerization Initiator—

Examples of the polymerization initiator include, but are not limited to, thermal polymerization initiators and photopolymerization initiators. Among these polymerization initiators, photopolymerization initiators are more preferable in terms of a design property based on a bossed-recessed shape and durability of image quality.

It is preferable that the photopolymerization initiator produce active species such as a radical or a cation upon application of energy of an active energy ray and initiate polymerization of a polymerizable compound. As the polymerization initiator, it is suitable to use a known radical polymerization initiator, cation polymerization initiator, base generator, or a combination thereof. Of these, a radical polymerization initiator is preferable.

The polymerization initiator preferably accounts for 1 percent by weight to 20 percent by weight and more preferably accounts for 5 percent by weight to 15 percent by weight of the total amount of the curable composition to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds.

In addition, a polymerization accelerator (sensitizer) is optionally used together with the polymerization initiator.

The polymerization accelerator is not particularly limited and may be appropriately selected depending on the intended purpose. Examples of the polymerization accelerator include, but are not limited to, amine compounds such as trimethylamine, methyl dimethanolamine, triethanolamine, p-diethylaminoacetophenone, ethyl p-dimethylaminobenzoate, p-dimethylaminobenzoic acid-2-ethyl hexyl, N,N-dimethylbenzylamine, and 4,4′-bis(diethylamino)benzophenone.

The content of the polymerization accelerator is not particularly limited and may be appropriately set depending on the kind and the amount of the polymerization initiator used.

### —Surfactant—

A surfactant may be added in order to reduce surface tension for leveling adjustment during application over the base material and adjustment of spreading of a defoaming agent. Examples of the surfactant include, but are not limited to, glycerin fatty acid esters such as glycerin fatty acid ester, sorbitan fatty acid ester, fatty acid ester of polyethylene glycol, glyceryl monostearate, glyceryl monooleate, diglyceryl monostearate, and diglyceryl monoisostearate; glycol fatty acid esters such as propylene glycol monostearate; sorbitan fatty acid esters such as sorbitan monostearate and sorbitan monooleate; and sucrose stearic acid ester, POE (4.2) lauryl ether, POE (40) hydrogenated castor oil, POE (10) cetyl ether, POE (9) lauryl ether, POE (10) oleyl ether, POE (20) sorbitan monooleate, POE (6) sorbit monolaurate, POE (15) cetyl ether, POE (20) sorbitan monopalmitate, POE (15) oleyl ether, POE (100) hydrogenated castor oil, POE (20) POP (4) cetyl ether, POE (20) cetyl ether, POE (20) oleyl ether, POE (20) stearyl ether, POE (50) oleyl ether, POE (25) cetyl ether, POE (25) lauryl ether, POE (30) cetyl ether, and POE (40) cetyl ether. One of these surfactants may be used alone two or more of these surfactants may be used in combination.

The content of the surfactant is preferably, for example, 0.1% by mass or greater but 2% by mass or less relative to the total amount of the foamable layer forming liquid.

### —Filler—

Examples of the filler include, but are not limited to, aluminum hydroxide, magnesium hydroxide, barium hydroxide, calcium carbonate, magnesium carbonate, calcium sulfate, barium sulfate, ferrous hydroxide, basic zinc carbonate, basic lead carbonate, silica sand, clay, talc, silicas, titanium dioxide, and magnesium silicate. One of these fillers may be used alone or two or more of these fillers may be used in combination. Among these fillers, calcium carbonate, magnesium carbonate, aluminum hydroxide, and magnesium hydroxide are preferable.

### —Foaming Accelerator—

The foaming accelerator is not particularly limited and may be appropriately selected depending on the intended purpose. Examples of the foaming accelerator include, but are not limited to, zinc naphthenate, zinc acetate, zinc propionate, zinc 2-ethyl pentanoate, zinc 2-ethyl-4-methyl pentanoate, zinc 2-methyl hexanoate, zinc 2-ethyl hexanoate, zinc isooctylate, zinc n-octylate, zinc neodecanoate, zinc isodecanoate, zinc n-decanoate, zinc laurate, zinc myristate, zinc palmitate, zinc stearate, zinc isostearate, zinc 12-hydroxysterate, zinc behenate, zinc oleate, zinc linoleate, zinc linolenate, zinc ricinoleate, zinc benzoate, zinc o, m, or p-toluate, zinc p-t-butyl benzoate, zinc salicylate, zinc phthalate, zinc salt of phthalic acid monoalkyl (C4 to C18) ester, zinc dehydroacetate, zinc dibutyl dithiocarbamate, zinc aminocrotonate, zinc salt of 2-mercaptobenzothiazole, zinc pyrithione, and zinc complex of urea or diphenylurea. One of these foaming accelerators may be used alone or two or more of these foaming accelerators may be used in combination.

### —Thickener—

Examples of the thickener include, but are not limited to, polycyanoacrylate, polylactic acid, polyglycolic acid, polycaprolactone, polyacrylic acid alkyl ester, and polymethacrylic acid alkyl ester.

### —Preservative—

Examples of the preservative include, but are not limited to, substances that have been hitherto used and do not initiate polymerization of a monomer, such as potassium sorbate, sodium benzoate, sorbic acid, and chlorocresol.

### —Stabilizer—

The stabilizer serves to, for example, suppress polymerization of a monomer under storage. Examples of the stabilizer include, but are not limited to, anionic stabilizers and free radical stabilizers.

Examples of the anionic stabilizer include, but are not limited to, metaphosphoric acid, maleic acid, maleic anhydride, alkyl sulfonic acid, phosphorus pentoxide, iron (III) chloride, antimony oxide, 2,4,6-trinitrophenol, thiol, alkyl sulfonyl, alkyl sulfone, alkyl sulfoxide, alkyl sulfite, sultone, sulfur dioxide, and sulfur trioxide.

Examples of the free radical stabilizer include, but are not limited to, hydroquinone, and catechol, or derivatives thereof.

The foamable layer forming liquid used in the present disclosure can be produced by using the various components described above. The preparation devices and conditions are not particularly limited. For example, the foamable layer forming liquid can be prepared by subjecting the foaming agent, the liquid composition, etc. to a dispersion treatment using a dispersing machine such as a ball mill, a kitty mill, a disk mill, a pin mill, and a DYNO-MILL, and further mixing the resultant with a polymerization initiator, a surfactant, etc.

The static surface tension of the foamable layer forming liquid used in the present disclosure can be measured with, for example, an automatic surface tensiometer DY-300 available from Kyowa Interface Science, Inc. according to a plate method or a ring method. The static surface tension of the foamable layer forming liquid may be appropriately adjusted depending on application fields and devices used, and is preferably 15 mN/m or higher but 50 mN/m or lower at 25 degrees C.

The viscosity of the foamable layer forming liquid can be measured with, for example, a rheometer MCR301 available from Anton Paar GmbH and a cone plate CP25-1 at a shear rate of 10/s in a temperature range of from 20 degrees C. through 65 degrees C. The viscosity of the foamable layer forming liquid may be appropriately adjusted depending on application fields and devices used, and is preferably 10 mPa·s or higher but 20,000 mPa·s or lower at 25 degrees C.

The method for applying the foamable layer forming liquid over a base material is not particularly limited and may be appropriately selected depending on the intended purpose. Examples of the method include, but are not limited to, coating methods such as a knife coating method, a nozzle coating method, a die coating method, a lip coating method, a comma coating method, a gravure coating method, a rotary screen coating method, a reverse roll coating method, a roll coating method, a spin coating method, a kneader coating method, a bar coating method, a blade coating method, a casting method, a dipping method, and a curtain coating method, and an inkjet method.

In the present disclosure, in the foamable layer forming step, it is preferable to form the foamable layer by applying the foamable layer forming liquid containing a foaming agent and a polymerizable solvent (polymerizable compound) serving as the liquid composition over a base material and subsequently curing the foamable layer forming liquid.

The method for curing the foamable layer forming liquid when curing the foamable layer forming liquid is not particularly limited and may be appropriately selected depending on the intended purpose. For example, curing may be performed by an energy applying step.

The energy applying step is a step of applying energy to a target layer, and can be performed by, for example, an energy applying unit.

Examples of the energy include, but are not limited to, thermal energy and active energy rays.

When the energy is thermal energy, for example, the foamable layer may be cured and foamed at the same time by application of thermal energy to the foamable layer. In other words, the foaming step of foaming the foaming agent may be performed collectively when applying thermal energy to the curable composition to cure the curable composition. Moreover, when applying a defoaming agent to the foamable layer, for example, it is possible to three-dimensionally crosslink the region to which the defoaming agent is applied.

The unit configured to apply thermal energy is not particularly limited and may be appropriately selected depending on the intended purpose. Examples of the unit include, but are not limited to, infrared heaters, hot air heater, and heating rollers.

The heating temperature by application of thermal energy is not particularly limited and may be appropriately selected depending on the intended purpose so long as the foamable layer can be thermally cured, and is preferably higher than or equal to the thermal decomposition temperature of the foaming agent, and is preferably, for example, 100 degrees C. or higher but 200 degrees C. or lower.

When the energy is active energy rays, for example, the foamable layer is cured by irradiation of the foamable layer with active energy rays.

### —Active Energy Rays—

Active energy rays are not particularly limited, so long as they are able to give necessary energy for allowing polymerization reaction of polymerizable components in the composition to proceed. Examples of the active energy rays include, but are not limited to, electron beams, α-rays, ß-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

The curing conditions are not particularly limited and may be appropriately selected depending on the intended purpose. In the case of ultraviolet rays, an irradiator that can emit an intensity of 6 W/cm or higher from an irradiation distance of 2 mm is preferable.

In the case of electron beams, an accelerating voltage that gives a dose of 15 kGy or higher to a farthest position of the curing target from the electron beam irradiator is preferable.

The average thickness of the foamable layer (before foaming) is not particularly limited, may be appropriately selected depending on the intended purpose, and is preferably 50 micrometers or greater, more preferably 100 micrometers or greater, yet more preferably 250 micrometers or greater, and particularly preferably 300 micrometers or greater but 500 micrometers or less.

When the average thickness of the foamable layer (before foaming) is 50 micrometers or greater, the foamable layer can have a height difference by bosses and recesses and an excellent design property based on a bossed-recessed shape.

The average thickness of the foamable layer after foaming is not particularly limited, may be appropriately selected depending on the intended purpose, and is preferably 100 micrometers or greater, more preferably 310 micrometers or greater, yet more preferably 400 micrometers or greater, and particularly preferably 400 micrometers or greater but 2,000 micrometers or less.

When the average thickness of the foamable layer after foaming is 100 micrometers or greater, the foamable layer has a height difference by bosses and recesses attributable to a defoaming agent and an excellent design property based on a bossed-recessed shape.

The average thickness can be obtained by scraping the foamable layer at different five positions, measuring the height of the scraped portions from the base material to the surface of the foamable layer with, for example, a laser microscope VK-X100 available from Keyence Corporation, and calculating the average of the measured heights.

In the foamable layer of the present disclosure, the average thickness, after foaming, of a foamed region of the foamable layer is preferably 1.3 or more times and more preferably 2 or more times greater than the average thickness before foaming. In this way, the foamable layer can have a height difference by bosses and recesses and an excellent design property based on a bossed-recessed shape.

### <Defoaming Agent Applying Step and Defoaming Agent Applying Unit>

The defoaming agent applying step is a step of applying and contacting a defoaming agent containing a multifunctional monomer to a predetermined region of the foamable layer.

The defoaming agent applying unit is a unit configured to apply and contact a defoaming agent containing a multifunctional monomer to a predetermined region of the foamable layer.

The method for applying and contacting the defoaming agent is not particularly limited and may be appropriately selected depending on the intended purpose. An inkjet method is preferable in terms of flexible adaptability to various foaming patterns (defoaming patterns). In other words, in the present disclosure, application of the defoaming agent by an inkjet method in the defoaming agent applying step is more flexibly adaptable to various foaming patterns (defoaming patterns).

For example, the driving method of a discharging head used in the inkjet method may be a method employing, for example, PZT as a piezoelectric element actuator, a method of applying thermal energy, a method employing an on-demand head using an electrostatic force-applied actuator, and a method employing a continuous jet-type charge control-type head.

The application amount of the defoaming agent is not particularly limited, may be appropriately selected depending on the intended purpose, and is preferably 3 microliters/cm² or less with respect to the surface of the foamable layer.

The discharging speed of the defoaming agent is not particularly limited, may be appropriately selected depending on the intended purpose, and is preferably 5 m/s or higher and more preferably 5 m/s or higher but 15 m/s or lower. In this case, the defoaming agent can be discharged more stably. The dot density (image resolution) of the liquid droplets of the defoaming agent to be discharged is preferably 240 dpi×240 dpi (dot per inch) or greater. The defoaming agent contains a multifunctional monomer and further contains other components as needed.

As the multifunctional monomer, the same multifunctional monomer as used in the curable composition of the foamable layer can be used. Examples of the multifunctional monomer include, but are not limited to, 1,6-hexanediol di(meth)acrylate, 1,3-butylene glycol diacrylate, 1,4-butanediol diacrylate, diethylene glycol diacrylate, neopentyl glycol diacrylate, and dipropylene glycol diacrylate. Moreover, mixtures of different multifunctional monomers, mixtures of multifunctional monomers with monofunctional monomers, mixtures of multifunctional oligomers with monofunctional monomers, and mixtures of monofunctional monomers, multifunctional monomers, and multifunctional oligomers may also be used.

The multifunctional monomer three-dimensionally crosslinks when, for example, energy is applied to the multifunctional monomer. With the defoaming agent containing the multifunctional monomer, it is possible to accurately control ON or OFF of foaming (i.e., whether or not to foam a predetermined region of the foamable layer) by applying the defoaming agent to the predetermined region and applying energy to the defoaming agent. This leads to an advantage that an excellent design property based on a bossed-recessed shape can be imparted to a printed matter.

The defoaming agent may contain other components such as a polymerization initiator and a surfactant, like the foamable layer forming liquid.

The static surface tension of the defoaming agent may be appropriately adjusted depending on application fields and devices used, and is preferably 20 mN/m or higher but 55 mN/m or lower at 25 degrees C.

The viscosity of the defoaming agent may be appropriately adjusted depending on application fields and devices used, and is preferably 1 mPa·s or higher but 100 mPa·s or lower at 25 degrees C.

It is possible to identify a predetermined region to which the defoaming agent is to be applied and brought into contact in the foamable layer, based on, for example, data indicating bosses and recesses of a printed matter to be produced. In the defoaming agent applying step, for example, the defoaming agent is applied and brought into contact with a portion corresponding to a recessed portion (a region in which the foamable layer is not to be foamed) in the data indicating bosses and recesses of a printed matter to be produced. This makes it possible to suppress foaming of the foamable layer in the foaming step and form an arbitrary bossed-recessed shape.

### <Ink Receiving Layer Forming Step and Ink Receiving Layer Forming Unit>

The ink receiving layer forming step is a step of forming an ink receiving layer containing a polymer of a polymerizable compound a over the foamable layer.

The ink receiving layer forming unit is a unit configured to form an ink receiving layer containing a polymer of a polymerizable compound a over the foamable layer.

The ink receiving layer forming unit is not particularly limited and may be appropriately selected depending on the intended purpose. Examples of the ink receiving layer forming unit include, but are not limited to, combination of a known material applying unit (e.g., a coating unit and a discharging unit) and a known energy applying unit (e.g., a thermal energy applying unit and an active energy ray irradiation unit), like the foamable layer forming unit.

The ink receiving layer forming step is not particularly limited so long as an ink receiving layer can be formed. For example, it is preferable that the material applying unit apply an ink receiving layer forming liquid containing a polymerizable compound a over the foamable layer to form a film, and then the energy applying unit cure the film to form an ink receiving layer. In other words, in the ink receiving layer forming step, it is preferable to form an ink receiving layer by applying an ink receiving layer forming liquid containing a polymerizable compound a over the foamable layer and then curing the ink receiving layer forming liquid.

The timing at which the ink receiving layer forming liquid is cured is not particularly limited and may be appropriately selected depending on the intended purpose. For example, the ink receiving layer may be collectively cured with at least one of the foamable layer and an ink that forms an image, when curing the foamable layer and the ink that forms an image. It is preferable to cure the ink receiving layer collectively with the ink that forms an image.

### <<Ink Receiving Layer Forming Liquid>>

The ink receiving layer forming liquid contains a polymerizable compound a, preferably contains a polymerization initiator, and further contains other components as needed.

—Polymerizable Compound a—

The polymerizable compound a may be the same as the polymerizable solvent (polymerizable compound) of the foamable layer forming liquid of the foamable layer described above.

### —Polymerization Initiator—

The polymerization initiator may be the same as the polymerization initiator of the foamable layer forming liquid of the foamable layer described above.

### —Other Components—

The other components of the ink receiving layer forming liquid are not particularly limited and may be appropriately selected depending on the intended purpose. For example, the same components as the other components in the foamable layer forming liquid may be selected.

The static surface tension of the ink receiving layer forming liquid may be appropriately adjusted depending on application fields and devices used, and is preferably 15 mN/m or higher but 50 mN/m or lower at 25 degrees C.

The viscosity of the ink receiving layer forming liquid may be appropriately adjusted depending on application fields and devices used, and is preferably 10 mPa·s or higher but 20,000 mPa·s or lower at 25 degrees C.

The method for applying the ink receiving layer forming liquid over the foamable layer is not particularly limited and may be appropriately selected depending on the intended purpose. Examples of the method include, but are not limited to, coating methods such as a knife coating method, a nozzle coating method, a die coating method, a lip coating method, a comma coating method, a gravure coating method, a rotary screen coating method, a reverse roll coating method, a roll coating method, a spin coating method, a kneader coating method, a bar coating method, a blade coating method, a casting method, a dipping method, and a curtain coating method, and an inkjet method.

The application amount of the ink receiving layer forming liquid (the average film thickness of an ink receiving layer) is not particularly limited, may be appropriately selected depending on the intended purpose, and is preferably 1 micrometer or greater and more preferably 2 micrometers or greater but 50 micrometers or less. When the average film thickness of the ink receiving layer is 1 micrometer or greater, a better image quality can be obtained. The film thickness as used herein refers to a film thickness of the ink receiving layer forming liquid after cured (or of an ink receiving layer thusly formed). The average film thickness can be obtained by microscopically observing a coating film cross-section including the foamable layer and the ink receiving layer, measuring the thickness of the ink receiving layer at different five positions, and calculating the average of the measured thicknesses.

The method for curing the ink receiving layer forming liquid when curing the ink receiving layer forming liquid is not particularly limited and may be appropriately selected depending on the intended purpose. For example, curing may be performed by an energy applying step, like the foamable layer.

When the energy is thermal energy, the ink receiving layer can be cured by application of thermal energy to the ink receiving layer.

The heating temperature by application of thermal energy is not particularly limited and may be appropriately selected depending on the intended purpose so long as the ink-receiving layer can be thermally cured.

When the energy is active energy rays, the ink receiving layer can be cured by irradiation of the ink receiving layer with active energy rays.

The curing conditions are not particularly limited and may be appropriately selected depending on the intended purpose. In the case of ultraviolet rays, an irradiator that can emit an intensity of 6 W/cm or higher from an irradiation distance of 2 mm is preferable.

In the case of electron beams, an accelerating voltage that gives a dose of 15 kGy or higher to a farthest position of the curing target from the electron beam irradiator is preferable.

### <Image Forming Step and Image Forming Unit>

The image forming step is a step of applying an ink containing a colorant and a polymerizable compound b over the ink receiving layer to form an image.

The image forming unit is a unit configured to apply an ink containing a colorant and a polymerizable compound b over the ink receiving layer to form an image.

The image forming unit is not particularly limited and may be appropriately selected depending on the intended purpose. Examples of the image forming unit include, but are not limited to, combination of a known material applying unit (e.g., a coating unit and a discharging unit) and a known energy applying unit (e.g., a thermal energy applying unit and an active energy ray irradiation unit).

The image forming step is not particularly limited so long as an image can be formed. For example, it is preferable that the material applying unit apply an ink containing a colorant and a polymerizable compound b over the ink receiving layer to form a film, and then the energy applying unit cure the film to form an image. In other words, in the image forming step, it is preferable to form an image by applying the ink over the ink receiving layer and then curing the ink. In this way, durability of the image against, for example, external shocks can be better improved.

The timing at which the ink is cured is not particularly limited and may be appropriately selected depending on the intended purpose. For example, the ink that forms an image may be collectively cured with at least one of the foamable layer and the ink receiving layer, when curing the foamable layer and the ink receiving layer. It is preferable to cure the ink that forms an image collectively with the ink receiving layer.

In other words, in the present disclosure, it is preferable to collectively perform curing of the ink receiving layer forming liquid in the ink receiving layer forming step and curing of the ink in the image forming step. In this way, in the present disclosure, the ink receiving layer and an image formed with the ink can be better integrated, making it possible to better improve color developability of the image formed with the ink and better improve durability of the image against, for example, external shocks.

The method for applying the ink over the ink receiving layer is not particularly limited and may be appropriately selected depending on the intended purpose. An inkjet method is preferable in terms of productivity and flexible adaptability to multiple items in small lots. In other words, in the present disclosure, application of the ink over the ink receiving layer by an inkjet method in the image forming step can improve productivity and is flexibly adaptable to production of multiple printed matters in small lots.

For example, the driving method of a discharging head used in the inkjet method may be a method employing, for example, PZT (lead titanate zirconate) as a piezoelectric element actuator, a method of applying thermal energy, a method employing an on-demand head using an electrostatic force-applied actuator, and a method employing a continuous jet-type charge control-type head.

Three, four, or more kinds of inks may be applied in the image forming step depending on the colorants (pigments) contained in the inks. For example, these inks are applied by different inkjet heads. Alternatively, one head including a plurality of nozzle lines may be used to discharge different inks from different nozzle lines. It is preferable to change the head nozzle density at which each ink is discharged, depending on the image resolution of the image to be formed in the image forming step and the number of times to scan the head. For example, the head nozzle density may be 240 npi (nozzle per inch), 300 npi, 600 npi, and 1,200 npi.

The application amount of the ink is not particularly limited, may be appropriately selected depending on the intended purpose, and is preferably 3 microliters/cm′ or less with respect to the surface of the ink receiving layer. When the application amount of the ink is 3 microliters/cm² or less with respect to the surface of the ink receiving layer, unnecessary coalescing of ink droplets, color mixing of inks, and reduction of color gamut can be better suppressed, making it possible to obtain a better image quality.

The discharging speed of the ink is not particularly limited, may be appropriately selected depending on the intended purpose, and is preferably 5 m/s or higher and more preferably 5 m/s or higher but 15 m/s or lower. In this case, the ink can be discharged more stably. The dot density (image resolution) of the liquid droplets of the ink to be discharged is preferably 240 dpi×240 dpi (dot per inch) or higher.

The shape of the image is not particularly limited and may be appropriately selected depending on the intended purpose. For example, using an inkjet head, inks can be discharged based on data of the image on the printed matter to be produced, and an arbitrary image (colorant layer) can be formed.

### <<Ink>>

The ink contains a colorant and a polymerizable compound b, preferably contains a polymerization initiator, and further contains other components as needed.

### —Colorant—

As the colorant, various pigments and dyes may be used that impart black, white, magenta, cyan, yellow, green, orange, purple, and gloss colors such as gold and silver, depending on the intended purpose of the ink of the present and requisite properties thereof. A content of the colorant is not particularly limited, may be appropriately determined considering, for example, a desired color density and dispersibility in the composition, and is preferably from 0.1% by mass to 20% by mass and more preferably from 1% by mass to 10% by mass relative to the total mass (100% by mass) of the ink.

The colorant can be either inorganic or organic, and two or more of the colorants can be used in combination.

Specific examples of the inorganic pigments include, but are not limited to, carbon blacks (C.I. Pigment Black 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxazine pigments, thioindigo pigments, isoindolinone pigments, and quinophthalone pigments, dye chelates (e.g., basic dye chelates, acid dye chelates), dye lakes (e.g., basic dye lakes, acid dye lakes), nitro pigments, nitroso pigments, aniline black, and daylight fluorescent pigments.

The ink may further contain a dispersant in order to improve dispersibility of the pigment.

The dispersant is not particularly limited. Examples of the dispersant include, but are not limited to, dispersants commonly used to prepare pigment dispersions, such as polymeric dispersants.

The dyes are not particularly limited. Specific examples of the dyes include, but are not limited to acidic dyes, direct dyes, reactive dyes, and basic dyes. One of these dyes may be used alone or two or more of these dyes may be used in combination.

—Polymerizable Compound b—

The polymerizable compound b may be the same as the polymerizable solvent (polymerizable compound) of the foamable layer forming liquid of the foamable layer described above.

The content of the polymerizable compound b in the ink is not particularly limited, may be appropriately selected depending on the intended purpose, and is preferably 70% by mass or greater but 95% by mass or less relative to the total amount of the ink.

### —Polymerization Initiator—

The polymerization initiator may be the same as the polymerization initiator of the foamable layer forming liquid of the foamable layer described above.

The ink may further contain a dispersant in order to improve dispersibility of the pigment. The dispersant is not particularly limited. Examples of the dispersant include, but are not limited to, dispersants commonly used to prepare pigment dispersions, such as polymeric dispersants.

### —Other Components—

The other components of the ink are not particularly limited and may be appropriately selected depending on the intended purpose. Examples of the other components include, but are not limited to, an organic solvent, a surfactant, a polymerization inhibitor, a leveling agent, a defoaming agent, a fluorescent brightener, a permeation enhancing agent, a wetting agent (humectant), a fixing agent, a viscosity stabilizer, a fungicide, a preservative, an antioxidant, an ultraviolet absorbent, a chelate agent, a pH adjuster, and a thickener.

### —Organic Solvent—

The ink of the present disclosure optionally contains an organic solvent although it is preferable to spare it. The composition free of an organic solvent, in particular volatile organic compound (VOC), is preferable because it enhances safety at where the composition is handled and makes it possible to prevent pollution of the environment. Incidentally, the organic solvent represents a conventional non-reactive organic solvent, for example, ether, ketone, xylene, ethyl acetate, cyclohexanone, and toluene, which is clearly distinguished from reactive monomers. Furthermore, “free of” an organic solvent means that no organic solvent is substantially contained. The content thereof is preferably less than 0.1 percent by mass.

### —Preparation of Colorant Composition—

The ink used in the present disclosure can be prepared by using the various components described above. The preparation devices and conditions are not particularly limited. For example, the ink can be prepared by subjecting a pigment serving as a colorant, a dispersant, etc., to a dispersion treatment using a dispersing machine such as a ball mill, a kitty mill, a disk mill, a pin mill, and a DYNO-MILL to prepare a pigment liquid dispersion, and further mixing the pigment liquid dispersion with a polymerizable compound, a polymerization initiator, a polymerization inhibitor, and a surfactant.

The viscosity of the ink used in the present disclosure has no particular limit because it can be adjusted depending on the purpose and application devices. For example, if an ejecting device that ejects the compositions from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. In addition, it is particularly preferable to satisfy this viscosity range by the compositions free of the organic solvent described above. Incidentally, the viscosity can be measured by a cone plate rotary viscometer (VISCOMETER TVE-22L, manufactured by TOKI SANGYO CO., LTD.) using a cone rotor (1° 34′×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

The static surface tension of the ink may be appropriately adjusted depending on application fields and devices used, and is preferably 20 mN/m or higher but 55 mN/m or lower at 25 degrees C.

The method for curing the ink when curing the ink is not particularly limited and may be appropriately selected depending on the intended purpose. For example, curing may be performed by an energy applying step, like the foamable layer.

When the energy is thermal energy, for example, the colorant layer can be cured by application of thermal energy.

The heating temperature by application of thermal energy is not particularly limited and may be appropriately selected depending on the intended purpose so long as the colorant layer can be thermally cured.

When the energy is active energy rays, the colorant layer can be cured by irradiation of the colorant layer with active energy rays.

The curing conditions are not particularly limited and may be appropriately selected depending on the intended purpose. In the case of ultraviolet rays, an irradiator that can emit an intensity of 6 W/cm or higher from an irradiation distance of 2 mm is preferable.

In the case of electron beams, an accelerating voltage that gives a dose of 15 kGy or higher to a farthest position of the curing target from the electron beam irradiator is preferable.

### <Foaming Step and Foaming Unit>

The foaming step is a step of heating the foamable layer to foam (volume-expand) the foamable layer.

The foaming unit is a unit configured to heat the foamable layer to foam (volume-expand) the foamable layer.

The foaming unit is not particularly limited and may be appropriately selected depending on the intended purpose so long as the foaming unit is a unit that can foam the foaming agent in the foamable layer by heating. Examples of the foaming unit include, but are not limited to, infrared heaters, hot air heaters, and heating rollers.

The heating temperature in the heating step is not particularly limited and may be appropriately selected depending on the intended purpose so long as it is higher than or equal to the thermal decomposition temperature of the foaming agent, and is preferably, for example, 100 degrees C. or higher but 200 degrees C. or lower.

The timing at which the foaming step is performed is not particularly limited and may be appropriately selected depending on the intended purpose so long as the timing is at the same time as when or after the foamable layer forming step is performed. More specifically, for example, as described above, the foaming step may be collectively performed when curing the foamable layer forming liquid by application of thermal energy in the foamable layer forming step, or the foaming step may be performed after the foamable layer forming liquid is cured. Moreover, in the present disclosure, the foaming step may be performed after the ink receiving layer forming step and before the image forming step, or may be performed after formation of the various layers (e.g., a foamable layer and an ink receiving layer) and formation of an image are completed (i.e., after the image forming step).

In the present disclosure, it is preferable to perform the foaming step after the image forming step. In this way, in the present disclosure, the ink receiving layer forming step and the image forming step are to be performed on a foamable layer in an unfoamed state (i.e., a flat foamable layer having no bosses and recesses). Therefore, when forming an image by discharging an ink with, for example, an inkjet head, the ink can be stably landed on the ink receiving layer, making it possible to better improve color developability of the image formed.

The method for forming a foamed region and an unfoamed region when foaming the foamable layer is not limited to application of the defoaming agent described below, but may be appropriaely selected depending on the intended purpose. A foamed region and an unfoamed region of the foamable layer may be formed by, for example, selective heating of the region to be foamed in the foamable layer. In this case, for example, a laser irradiation unit may be used as the foaming unit.

### <Transparent Layer Forming Step and Transparent Layer Forming Unit>

The transparent layer forming step is a step of forming a transparent layer containing a polymer of a polymerizable compound c over at least one of the ink receiving layer and the image.

The transparent layer forming unit is a unit configured to form a transparent layer containing a polymer of a polymerizable compound c over at least one of the ink receiving layer and the image.

In the present disclosure, with the transparent layer forming step, it is possible to better improve durability of a bossed-recessed shape and an image that are formed, and to maintain an excellent design property based on the bossed-recessed shape and an excellent image quality for a long term.

The transparent layer forming unit is not particularly limited and may be appropriately selected depending on the intended purpose. Examples of the transparent layer forming unit include, but are not limited to, combination of a known material applying unit (e.g., a coating unit and a discharging unit) and a known energy applying unit (e.g., a thermal energy applying unit and an active energy ray irradiation unit), like the foamable layer forming unit.

In the present disclosure, a transparent layer refers to a layer having a haze [scattered light/total transmitted light×100(%)] of 8% or lower when measured in an optical characteristic test using HAZE-GARD I (a haze meter, available from Byk-Gardner Inc.).

In the present disclosure, the transparent layer forming step is performed after the ink receiving layer forming step or after the image forming step. In this way, a transparent layer can be formed over at least one of the ink receiving layer and an image. That is, in the present disclosure, a transparent layer may be formed between the ink receiving layer and an image, or may be formed over the ink receiving layer and an image. When an image (solid image) is formed all over the ink receiving layer, a transparent layer may be formed only over the image.

In the present disclosure, in the transparent layer forming step, it is preferable to form a transparent layer over at least an image. In other words, in the present disclosure, it is preferable to perform the transparent layer forming step after the image forming step to form a transparent layer over an image. In this way, in the present disclosure, it is possible to particularly improve durability of a bossed-recessed shape and an image that are formed, and maintain an excellent design property based on the bossed-recessed shape and an excellent image quality for a long term.

In the transparent layer forming step, for example, a material applying unit may apply a transparent layer forming liquid (clear ink) containing a polymerizable compound c to form a film, and then an energy applying unit may cure the film to form a transparent layer. In other words, in the transparent layer forming step, a film containing the polymerizable compound c is formed and cured, to form a transparent layer containing a polymer of the polymerizable compound c.

The transparent layer forming liquid (clear ink) contains a polymerizable compound c, preferably contains a polymerization initiator, and further contains other components as needed.

—Polymerizable Compound c—

The polymerizable compound c may be the same as the polymerizable solvent (polymerizable compound) of the foamable layer forming liquid of the foamable layer described above can be used. In the present disclosure, the polymerizable compound a, the polymerizable compound b, and the polymerizable compound c may be the same polymerizable compound or different polymerizable compounds.

### —Polymerization Initiator—

As the polymerization initiator, the same polymerization initiator as used in the foamable layer forming liquid of the foamable layer described above can be used.

### —Other Components—

The other components of the transparent layer forming liquid are not particularly limited and may be appropriately selected depending on the intended purpose. The same components as the other components in the foamable layer forming liquid may be selected.

As the transparent layer forming liquid (clear ink), the ink that is used in the image forming step but is free of a colorant can be used. “Free of a colorant” means that no colorant is substantially contained. The content of the colorant is preferably less than 0.1% by mass.

In terms of maintaining an excellent design property based on a bossed-recessed shape and an excellent image quality for a long term by forming a transparent layer, a preferable transparent layer forming liquid (clear ink) is an ink that is used in the image forming step but is free of a colorant and has a higher multifunctional monomer/oligomer content ratio than in the polymerizable compound b.

The static surface tension of the transparent layer forming liquid (clear ink) may be appropriately adjusted depending on application fields and devices used, and is preferably 20 mN/m or higher but 55 mN/m or lower at 25 degrees C.

The viscosity of the transparent layer forming liquid (clear ink) may be appropriately adjusted depending on application fields and devices used, and is preferably 1 mPa·s or higher but 100 mPa·s or lower at 25 degrees C. When applying the transparent layer forming liquid (clear ink) by an inkjet method, the viscosity of the transparent layer forming liquid (clear ink) is preferably 5 mPa·s or higher but 20 mPa·s or lower.

The method for applying the transparent layer forming liquid (clear ink) over at least one of the ink receiving layer and an image is not particularly limited and may be appropriately selected depending on the intended purpose. An inkjet method is preferable because an inkjet method can apply the transparent layer forming liquid (clear ink) over the ink receiving layer or an image in a contactless manner.

The application amount of the transparent layer forming liquid (clear ink) is not particularly limited, may be appropriately selected depending on the intended purpose, and is preferably 3 microliters/cm² or less over the surface of the ink receiving layer.

The discharging speed of the transparent layer forming liquid (clear ink) is not particularly limited, may be appropriately selected depending on the intended purpose, and is preferably 5 m/s or higher and more preferably 5 m/s or higher but 15 m/s or lower. In this way, the transparent layer forming liquid (clear ink) can be discharged more stably.

### <Base Material Surface Reforming Step and Base Material Surface Reforming Unit>

The base material surface reforming step is a step of applying a corona discharge treatment to a base material over which the foamable layer is to be formed, to reform the surface of the bae material.

The base material surface reforming unit is a unit configured to apply a corona discharge treatment to a base material over which the foamable layer is to be formed, to reform the surface of the base material.

The base material surface reforming unit is not particularly limited and may be appropriately selected depending on the intended purpose, so long as a corona discharge treatment can be applied to a base material. For example, TEC-4AX (available from Kasuga Denki, Inc.) can be used as the corona discharge treatment apparatus.

In the present disclosure, the base material surface reforming step is performed before the foamable layer forming step. That is, in the present disclosure, it is preferable that the base material surface reforming step of applying a corona discharge treatment to a base material over which the foamable layer is to be formed, to reform the surface of the base material be performed before the foamable layer forming step. This makes it possible to improve wettability and close adhesiveness of the foamable layer forming liquid over the base material. Therefore, the foamable layer after cured and foamed will have an improved close adhesiveness with the base material, making it possible to better improve durability of an image against, for example, external shocks.

Here, in the base material surface reforming step, for example, it is possible to reform the surface of a base material by applying a corona discharge treatment at a gap of 1 mm between the electrode and the surface of the base material, at 2 m/minute at 100 W using TEC-4AX (available from Kasuga Denki, Inc.) mentioned above.

### <Foamable Layer Surface Reforming Step and Foamable Layer Surface Reforming Unit>

The foamable layer surface reforming step is a step of applying a corona discharge treatment to the foamable layer to reform the surface of the foamable layer.

The foamable layer surface reforming unit is a unit configured to apply a corona discharge treatment to the foamable layer to reform the surface of the foamable layer.

The foamable layer surface reforming unit is not particularly limited and may be appropriately selected depending on the intended purpose, so long as a corona discharge treatment can be applied to the foamable layer. For example, TEC-4AX (available from Kasuga Denki, Inc.) can be used as the corona discharge treatment apparatus, like the base material surface reforming unit.

In the present disclosure, the foamable layer surface reforming step is performed after the foamable layer forming step. That is, in the present disclosure, it is preferable that the foamable layer surface reforming step of applying a corona discharge treatment to the foamable layer to reform the surface of the foamable layer be performed after the foamable layer forming step. In the present disclosure, this makes it possible to improve wettability and close adhesiveness of the ink receiving layer forming liquid over the foamable layer. Therefore, the ink receiving layer after curing and foaming will have an improved close adhesiveness with the foamable layer, making it possible to better improve durability of an image against, for example, external shocks.

Here, in the foamable layer surface reforming step, for example, it is possible to reform the surface of the foamable layer by applying a corona discharge treatment at a gap of 1 mm between the electrode and the surface of the base material, at 2 m/minute at 100 W using TEC-4AX (available from Kasuga Denki, Inc.) mentioned above.

### <Filler-Containing Layer Forming Step and Filler-Containing Layer Forming Unit>

The filler-containing layer forming step is a step of forming a filler-containing layer containing a filler over at least one of the ink receiving layer and an image.

The filler-containing layer forming unit is a unit configured to form a filler-containing layer containing a filler over at least one of the ink receiving layer and an image.

By providing a filler-containing layer containing a filler over at least one of the ink receiving layer and an image, it is possible to improve the strength of the foamable layer while maintaining a high design property based on a bossed-recessed shape, and to obtain a printed matter having an improved robustness such as abrasion resistance.

The filler-containing layer forming unit is not particularly limited and may be appropriately selected depending on the intended purpose. Examples of the filler-containing layer forming unit include, but are not limited to, combination of a known material applying unit (e.g., a coating unit and a discharging unit) and a known energy applying unit (e.g., a thermal energy applying unit and an active energy ray irradiation unit).

In the filler-containing layer forming step, for example, it is preferable that the material applying unit apply a filler-containing layer forming liquid containing a filler and a polymerizable compound d over at least one of the ink receiving layer and an image to form a film, and then the energy applying unit cure the film to form a filler-containing layer. In other words, in the present disclosure, in the filler-containing layer forming step, it is preferable to form a filler-containing layer by applying a filler-containing layer forming liquid containing a filler and a polymerizable compound d over at least one of the ink receiving layer and an image and then curing the filler-containing layer forming liquid.

### <<Filler-Containing Layer Forming Liquid>>

The filler-containing layer forming liquid contains a filler, preferably contains a polymerizable compound, and further contains other components as needed.

### —Filler—

The filler is not particularly limited and may be appropriately selected depending on the intended purpose, so long as the filler improves robustness of the printed matter such as abrasion resistance and scratch resistance, and has a high light transmittance.

The refractive index of the filler is preferably 1.46 or higher but 1.58 or lower. When the refractive index of the filler is 1.46 or higher but 1.58 or lower, a filler-containing layer having a high transparency can be formed because the refractive index of commonly available olefin and acrylic resins is approximately within this range. That is, when the refractive index is 1.46 or higher but 1.58 or lower, it is possible to suppress the refractive index difference between polymerizable compounds and the filler, reduce scattering of the filler, improve light transmittance of an image, and provide a printed matter suppressed in image density nonuniformity and image resolution degradation.

As the method for measuring the refractive index of the filler, for example, it is possible to disperse the filler in an acrylic-based polymerizable compound to prepare a filler liquid, spin-coat the filler liquid over a silicon wafer to form a film as a sample for refractive index measurement, and measure the refractive index of the sample with a commercially available spectroscopic ellipsometer.

Examples of the filler include, but are not limited to, inorganic fillers.

The material of the inorganic filler is not particularly limited and may be appropriately selected depending on the intended purpose. Preferable examples of the material of the inorganic filler include, but are not limited to, glass, silica, and alumina. One of these inorganic fillers may be used alone or two or more of these inorganic fillers may be used in combination.

Among these materials of the inorganic filler, glass is preferable. When the material of inorganic filler is glass, it is possible to control various properties of the inorganic filler with ease only by adjusting the composition of the glass. When using fused silica (with a refractive index of 1.46), crystalline silica (with a refractive index of 1.55), and aluminum hydroxide (with a refractive index of 1.58), which are commonly used as fillers, there is a need for adjusting the refractive index of the filler-containing liquid in order to obtain transparency, because these fillers have refractive indices specific to the substances. However, for example, when the filler-containing liquid contains an acrylic-based ultraviolet-ray-curable resin as a polymerizable compound, it is possible to take advantage of the latitude of refractive index adjustment characteristic to the glass filler, and easily match the refractive index of the filler with the refractive index of the resin formed of a polymerizable compound. This makes it possible to control the light transmittance (transparency) of the filler-containing layer.

Example of the glass include, but are not limited to, non-alkali silicate glass such as E-glass, alkali silicate glass such as C-glass, and ordinary soda-lime glass. One of these kinds of glass may be used alone or two or more of these kinds of glass may be used in combination.

It is preferable to apply a surface treatment to the filler in order to disperse the filler in a resin. A commercially available product can be used as such a filler. Examples of the commercially available product include, but are not limited to, FILATOMICTER SERIES available from Nippon Muki Co., Ltd.

The shape of the filler is not particularly limited and may be appropriately selected depending on the intended purpose. Examples of the shape of the filler include scaly shapes, fibrous shapes, powdery shapes, and bead-like shapes.

The structure of the filler is not particularly limited and may be approximately selected depending on the intended purpose.

When the shape of the filler is spherical and approximately spherical or when a fibrous filler is transformed to a spherical shape, the size of the filler expressed as the average primary particle diameter is preferably 0.1 micrometers or greater but 1.0 micrometer or less. When the average primary particle diameter of the filler is 0.1 micrometers or greater or 1.0 micrometer or less, the filler can be suppressed from sedimentation and can be well dispersed in the filler-containing layer forming liquid. Moreover, if aggregation of primary particles of the filler occurs, the diameter of the aggregate can be suppressed to about 5 micrometers or less at the maximum. Therefore, the filler can maintain adhesiveness with the foamable layer and improve abrasion resistance of a printed matter.

The method for measuring the average primary particle diameter is not particularly limited and may be appropriately selected depending on the intended purpose. Examples of the method include, but are not limited to, a laser diffraction/scattering particle size analyzer MT3000II (available from Microtrac Bel Corporation).

The method for measuring the average primary particle diameter of the filler contained in the filler-containing layer of a printed matter is not particularly limited and may be appropriately selected depending on the intended purpose. For example, the average primary particle diameter of the filler can be confirmed by picking a printed matter, stirring the printed matter in chloroform, and observing and measuring the diameter of the filler with an electron microscope.

When the shape of the filler is fibrous, the size of the filler expressed by the average length of the longer side thereof is preferably 0.6 micrometers or greater but 5 micrometers or less.

The content of the filler in the filler-containing layer forming liquid is preferably 0.1% by mass or greater but 20% by mass or less and more preferably 0.1% by mass or greater but 10% by mass or less. When the content of the filler in the filler-containing layer forming liquid is 0.1% by mass or greater but 20% by mass or less, the filler can improve rub resistance of a printed matter, have an improved close adhesiveness with the foamable layer, and provide a printed matter having a good image quality.

—Polymerizable Compound d—

The polymerizable compound d may be the same as the polymerizable solvent (polymerizable compound) of the foamable layer forming liquid of the foamable layer described above. In the present disclosure, the polymerizable compound a, the polymerizable compound b, the polymerizable compound c, and the polymerizable compound d may be the same polymerizable compound or different polymerizable compounds.

The content of a multifunctional monomer and a multifunctional oligomer in the filler-containing layer forming liquid is preferably 50% by mass or greater relative to the total amount of the polymerizable compound in the filler-containing layer forming liquid. When the content of a multifunctional monomer and a multifunctional oligomer in the filler-containing layer forming liquid is 50% by mass or greater relative to the total amount of the polymerizable compound in the filler-containing liquid, rub resistance and scratch resistance of the surface of a printed matter can be improved.

### —Other Components—

Examples of the other components include, but are not limited to, a polymerization initiator, a filler, a volume expansion promotor, a dispersant, a colorant, an organic solvent, an antiblocking agent, a thickener, a preservative, a stabilizer, a deodorant, a fluorescent agent, and an ultraviolet screener. The same components as used in the foamable layer forming liquid may be used as these components.

The filler-containing layer forming liquid may also contain a surfactant for adjustment of the static surface tension thereof.

### <Adhesive Layer Forming Step and Adhesive Layer Forming Unit>

The adhesive layer forming step is a step performed before the foamable layer forming step for forming an adhesive layer over a base material for bonding the base material and the foamable layer with each other.

The adhesive layer forming unit is unit configured to, before the foamable layer forming unit forms the foamable layer, form an adhesive layer over a base material for bonding the base material and the foamable layer with each other.

By providing an adhesive layer, it is possible to obtain a printed matter having an excellent durability for maintaining an excellent design property based on a bossed-recessed shape and an excellent image quality for a long term.

The adhesive layer forming unit is not particularly limited and may be appropriately selected depending on the intended purpose. Examples of the adhesive layer forming unit include, but are not limited to, combination of a known material applying unit (e.g., a coating unit and a discharging unit) and a known energy applying unit (e.g., a thermal energy applying unit and an active energy ray irradiation unit).

In the adhesive layer forming step, for example, the material applying unit may apply an adhesive layer forming liquid over a base material to form a film, and then the energy applying unit may cure the film to form an adhesive layer. In other words, in the present disclosure, for example, in the adhesive layer forming step, an adhesive layer is formed by application of an adhesive layer forming liquid for forming an adhesive layer over a base material and subsequent curing of the adhesive layer forming liquid.

### <<Adhesive Layer>>

The adhesive layer is not particularly limited and may be appropriately selected depending on the intended purpose so long as the adhesive layer can maintain adhesiveness (close adhesiveness) between a base material and the foamable layer when the foamable layer is foamed (volume-expanded).

The structure of the adhesive layer is not particularly limited and may be appropriately selected depending on the intended purpose so long as the adhesive layer can be provided between a base material and a foamable layer. The adhesive layer may be a single-layer structure (including one layer) or a multilayer structure (including a plurality of layers). For example, when the adhesive layer is a multilayer structure, it is possible to provide any other layer or structure between the adhesive layer and another adhesive layer so long as adhesiveness (close adhesiveness) between a base material and the foamable layer can be maintained. The adhesive layer may directly bond a base material and the foamable layer with each other or indirectly bond a base material and the foamable layer with each other. In the following description, the adhesive layer may be referred to as “intermediate layer” because it is provided between a base material and the foamable layer.

### —Adhesive Layer Forming Liquid—

The adhesive layer forming liquid contains, for example, at least one of a polymerizable compound e, a dispersible resin, and a dissolved resin, preferably further contains solid particles, and further contains other materials as needed. One of these materials may be used alone or two or more of these materials may be used in combination.

Hence, in the adhesive layer forming step, for example, the adhesive layer is formed by application of the adhesive layer forming liquid for forming the adhesive layer over a base material and subsequent curing of the adhesive layer forming liquid, and the adhesive layer forming liquid contains at least one of a polymerizable compound e, a dispersible resin, and a dissolved resin.

The polymerizable compound e may be the same as the polymerizable solvent (polymerizable compound) of the foamable layer forming liquid of the foamable layer described above. In the present disclosure, the polymerizable compound a, the polymerizable compound b, the polymerizable compound c, the polymerizable compound d, and the polymerizable compound e may be the same polymerizable compound or different polymerizable compounds.

Examples of the polymerizable compound e include, but are not limited to, polymerizable compounds from which polymers having a low glass transition point can be obtained, and polymerizable compounds having a functional group such as a hydroxyl group, a carboxyl group, an epoxy group, a sulfo group, and a phospho group at a molecular end.

One of these polymerizable compounds may be used alone or two or more of these polymerizable compounds may be used in combination.

Examples of the polymerizable compounds from which polymers having a low glass transition point can be obtained include, but are not limited to, polyethylene glycol (600) diacrylate (Tg: −42 degrees C.) as a compound containing an ethylene oxide skeleton, and tridecyl acrylate (Tg: −55 degrees C.) and isodecyl acrylate (Tg: −60 degrees C.) as compounds containing an alkyl straight chain. When the polymerizable compound e is one from which a polymer having a low glass transition point can be obtained, flexibility of the adhesive layer to be obtained can be improved. This makes it possible to improve close adhesiveness between the foamable layer after foamed and a base material, and improve durability of the printed matter to be obtained.

Examples of the polymerizable compound having a functional group such as a hydroxyl group, a carboxyl group, an epoxy group, a sulfo group, and a phospho group at a molecular end include, but are not limited to, 1,4-cyclohexane dimethanol monoacrylate, 2-acryloyloxyethyl succinate, 4-hydroxybutyl acrylate glycidyl ether, 2-acrylamide-2-methylpropane sulfonic acid, and 2-hydroxyethyl methacrylate acid phosphate.

The content of the polymerizable compound e relative to the total amount of the adhesive layer forming liquid is preferably 1% by mass or greater but 99% by mass or less and more preferably 10% by mass or greater but 95% by mass or less.

The dispersible resin is not particularly limited and may be appropriately selected depending on the intended purpose. Examples of the dispersible resin include, but are not limited to, acrylic-based resins, vinyl acetate-based resin, styrene-butadiene-based resins, vinyl chloride-based resins, acrylic-styrene-based resins, butadiene-based resins, styrene-based resins, and epoxy-based resins. One of these dispersible resins may be used alone or two or more of these dispersible resins may be used in combination.

The particle diameter of the resin component in the dispersible resin is not particularly limited so long as the resin component can form an emulsion, and is preferably 150 nm or less and more preferably 5 nm or greater but 100 nm or less. A commercially available product can be used as the dispersible resin. Examples of the commercially available product include, but are not limited to, BONCOAT W-26 (available from DIC Corporation) and BONCOAT W-386 (available from DIC Corporation). One of these commercially available products may be used alone or two or more of these commercially available products may be used in combination.

The content of the solid component of the dispersible resin relative to the total amount of the adhesive layer forming liquid is preferably 1% by mass or greater but 99% by mass or less and more preferably 10% by mass or greater but 95% by mass or less.

The dissolved resin (solvent-type resin) is not particularly limited and may be appropriately selected depending on the intended purpose so long as it is a resin in a state of being dissolved in a solvent. Examples of the dissolved resin include, but are not limited to, resins obtained by dissolving resins such as acrylic-based resins and urethane-based resins in solvents such as methyl ethyl ketone, dioxane, hexane, ethyl acetate, and butyl acetate. A commercially available product can be used as the dissolved resin. Examples of the commercially available product include, but are not limited to, FINETACK CT-3088, FINETACK CT-3850, FINETACK CT-5020, FINETACK CT-5030, FINETACK CT-6030, QUICKMASTER SPS-900-LV, QUICKMASTER SPS-945NT, and QUICKMASTER SPS-1040NT-25 (all available from DIC Corporation). One of these commercially available products may be used alone or two or more of these commercially available products may be used in combination.

The content of the dissolved resin relative to the total amount of the adhesive layer forming liquid is preferably 1% by mass or greater but 99% by mass or less and more preferably 10% by mass or greater but 95% by mass or less.

The solid particles are particles different from the dispersible resin described above, and are not particularly limited and may be appropriately selected depending on the intended purpose so long as the solid particles can improve wettability of a base material and suppress deformation of the adhesive layer. Examples of the solid particles include, but are not limited to, solid particles having a hydroxyl group on the surface thereof. Solid particles having a hydroxyl group on the surface thereof can improve wettability of the surface of a base material and suppress deformation of the adhesive layer. This makes it possible to improve adhesiveness (close adhesiveness) between a base material and the foamable layer after foamed.

A commercially available product can be used as the solid particles. Examples of the commercially available product include, but are not limited to, ORGANOSILICASOL MA-ST-M, IPA-ST, and MEK-ST-UP (available from Nissan Chemical Corporation). One of these commercially available products may be used alone or two or more of these commercially available products may be used in combination.

The content of the solid component of the solid particles relative to the total amount of the adhesive layer forming liquid is preferably 1% by mass or greater but 50% by mass or less and more preferably 5% by mass or greater but 30% by mass or less.

The average thickness (application amount) of the adhesive layer is not particularly limited, may be appropriately selected depending on the intended purpose, and is preferably 5 micrometers or greater. When the average thickness (application amount) of the adhesive layer is 5 micrometers or greater, close adhesiveness between a base material and the foamable layer can be better improved. The average thickness is the thickness after curing and drying. The average thickness (application amount) of the adhesive layer can be obtained by scraping the intermediate layer at different five positions, measuring the height of the scraped portions from the base material to the surface of the intermediate layer with, for example, a laser microscope VK-X100 available from Keyence Corporation, and calculating the average of the measured heights.

The method for forming the adhesive layer over a base material is not particularly limited and may be appropriately selected depending on the intended purpose. Examples of the method include, but are not limited to, coating methods such as a knife coating method, a nozzle coating method, a die coating method, a lip coating method, a comma coating method, a gravure coating method, a rotary screen coating method, a reverse roll coating method, a roll coating method, a spin coating method, a kneader coating method, a bar coating method, a blade coating method, a casting method, a dipping method, and a curtain coating method, and an inkjet method.

It is preferable to apply a surface treatment such as a corona treatment to a base material before forming the adhesive layer, in order to improve uniformity and close adhesiveness of the adhesive layer coating film.

### <Other Steps and Other Units>

The other steps are not particularly limited and may be appropriately selected depending on the intended purpose. Examples of the other steps include, but are not limited to, a protective layer forming step of forming a protective layer different from a transparent layer, an embossing step, a bending step, a cutting step, and a controlling step.

The other units are not particularly limited and may be appropriately selected depending on the intended purpose. Examples of the other units include, but are not limited to, a protective layer forming unit configured to form a protective layer different from a transparent layer, an embossing unit, a bending unit, a cutting unit, and a controlling unit.

### <<Embossing Step and Embossing Unit>>

The embossing step is a step of forming a boss/recess pattern on a printed matter.

The embossing unit is a unit configured to form a boss/recess pattern on a printed matter.

The embossing step may appropriately select and use such methods as embossing, chemical embossing, rotary screen processing, and raised printing that are commonly employed for imparting bosses and recesses to wallpaper and decorative materials.

Examples of the embossing unit include, but are not limited to, a unit configured to emboss a printed matter with a cooling roller after heating, and a unit configured to emboss a printed matter simultaneously with heating using heat roller embossing.

The embossing depth of embossing is preferably 0.08 mm or greater but 0.50 mm or less. When the embossing depth is 0.08 mm or greater, a three-dimensional appearance can be expressed. When the embossing depth is 0.50 mm or less, the abrasion resistance of the surface can be improved.

Examples of the shapes of the boss/recess pattern formed by embossing include wood texture grooves, bosses and recesses over slate surface, cloth surface texture, satin, grey, hairline, and hatching pattern.

### <Printed Matter>

A printed matter of the present disclosure includes a cell-containing layer containing cells, an ink receiving layer positioned over the cell-containing layer and containing a polymer A, and an image positioned over the ink receiving layer and formed of a cured product of an ink containing a colorant and a polymer B, preferably includes a transparent layer, and further includes other layers as needed.

The printed matter of the present disclosure can be suitably produced by the printed matter producing method and a printed matter producing apparatus of the present disclosure. A preferred embodiment of the printed matter of the present disclosure may be the same as a preferred embodiment of a printed matter according to the printed matter producing method of the present disclosure.

### <<Cell-Containing Layer>>

The cell-containing layer is not particularly limited and may be appropriately selected depending on the intended purpose so long as the cell-containing layer is a layer containing cells, and is preferably a layer containing a foaming agent that has been foamed. The cell-containing layer is preferably a layer containing, for example, a porous portion.

That is, the cell-containing layer of the printed matter of the present disclosure can be suitably formed by the foamable layer forming step and the foaming step of the printed matter producing method of the present disclosure. Therefore, a preferred embodiment of the cell-containing layer of the printed matter of the present disclosure may be the same as a preferred embodiment of the foamable layer according to the printed matter producing method of the present disclosure.

### <<Ink Receiving Layer>>

The ink receiving layer is positioned over the cell-containing layer and contains a polymer A.

The ink receiving layer of the printed matter of the present disclosure can be suitably formed by the ink receiving layer forming step of the printed matter producing method of the present disclosure. Therefore, a preferred embodiment of the ink receiving layer of the printed matter of the present disclosure may be the same as a preferred embodiment of the ink receiving layer according to the printed matter producing method of the present disclosure.

The polymer A contained in the ink receiving layer of the printed matter of the present disclosure is not particularly limited and may be appropriately selected depending on the intended purpose so long as it is a polymer, and may be a polymer of the polymerizable compound a described above.

### <<Image>>

The image of the printed matter of the present disclosure is positioned over the ink receiving layer and formed of a cured product of an ink containing a colorant and a polymer B.

The image of the printed matter of the present disclosure can be suitably formed by the image forming step of the printed matter producing method of the present disclosure. Therefore, a preferred embodiment of the image of the printed matter of the present disclosure may be the same as a preferred embodiment of the image according to the printed matter producing method of the present disclosure.

Here, as the ink contained in the image of the printed matter of the present disclosure, for example, the same ink as used in the image forming step described above can be used. The polymer B contained in the ink that forms the image of the printed matter of the present disclosure is not particularly limited and may be appropriately selected depending on the intended purpose so long as it is a polymer, and may be, for example, a polymer of the polymerizable compound b described above.

### <<Transparent Layer>>

The printed matter of the present disclosure preferably includes a transparent layer positioned over at least one of the ink receiving layer and the image.

The transparent layer of the printed matter of the present disclosure can be suitably formed by the transparent layer forming step of the printed matter producing method of the present disclosure. Therefore, a preferred embodiment of the transparent layer of the printed matter of the present disclosure may be the same as a preferred embodiment of the transparent layer according to the printed matter producing method of the present disclosure.

### <<Other Layers>>

Other layers of the printed matter of the present disclosure are not particularly limited and may be appropriately selected depending on the intended purpose.

A printed matter producing apparatus of the present disclosure used in the printed matter producing method of the present disclosure will be described in detail with reference to the drawings.

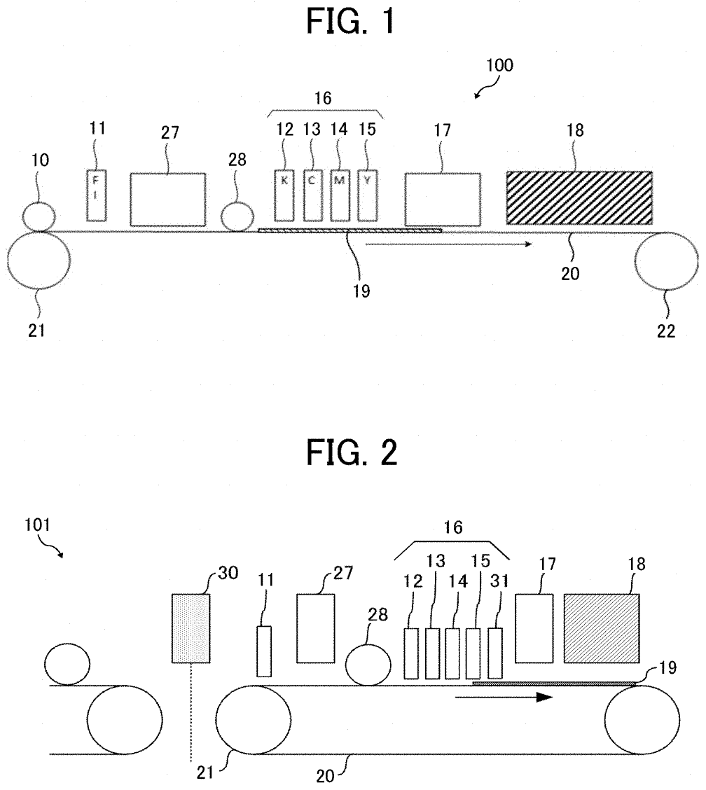

FIG. 1 is a schematic view illustrating an example of the printed matter producing apparatus of the present disclosure. The printed matter producing apparatus 100 of FIG. 1 includes a coating roller 10 configured to apply the foamable layer forming liquid over a base material 19, and at the downstream of the coating roller 10, a defoaming agent head 11, a discharging head 16 including a head 12 for black, a head 13 for cyan, a head 14 for magenta, and a head 15 for yellow, active energy ray irradiators 17 and 27, a heater 18, and a coating roller 28 configured to apply an ink receiving layer forming liquid over the base material 19 over which the foamable layer forming liquid is applied. In FIG. 1, the reference numeral 20 denotes a conveyor belt, the reference numeral 21 denotes a sending roller counter to the coating roller 20, and the reference numeral 22 denotes a winding roller.

With the conveyor belt 20 wound by the winding roller 22, the base material 19 is conveyed in the direction of the arrow of FIG. 1.

First, the coating roller 10 applies the foamable layer forming liquid over the surface of the base material 19, and the active energy ray irradiator 27 irradiates the base material 19 over which the foamable layer forming liquid is applied with active energy rays at a predetermined irradiation condition to cure the foamable layer forming liquid, to form a foamable layer. That is, in this example, the coating roller 10 and the active energy ray irradiator 27 are an example of the foamable layer forming unit.

Next, with the base material 19 scanned at a predetermined speed, the defoaming agent head 11 discharges the defoaming agent to a predetermined region of the foamable layer to bring the defoaming agent into contact with the predetermined region. That is, in this example, the defoaming agent head 11 is an example of the defoaming agent applying unit. As described above, it is possible to identify the predetermined region to which the defoaming agent is applied in the foamable layer, based on, for example, data indicating bosses and recesses of a printed matter to be produced.

Next, the coating roller 28 applies the ink receiving layer forming liquid over the foamable layer.

Next, the heads for the respective colors, namely the head 12 for black, the head 13 for cyan, the head 14 for magenta, and the head 15 for yellow discharge black, cyan, magenta, and yellow inks by an inkjet method. Subsequently, the active energy ray irradiator 17 irradiates the base material 19 over which the inks are applied with active energy rays at a predetermined irradiation condition to cure the ink receiving layer forming liquid and the inks, to form an ink receiving layer and an image. That is, in this example, the coating roller 28 and the active energy ray irradiator 17 are an example of the ink receiving layer forming unit, and the discharging head 16 and the active energy ray irradiator 17 are an example of the image forming unit.

Next, the heater 18 heats the foamable layer formed, to foam the foamable layer. That is, in this example, the heater 18 is an example of the foaming unit.

In this way, the printed matter produced by the printed matter producing apparatus 100 can be provided with an excellent design property based on a bossed-recessed shape and an excellent image quality and can maintain the excellent design property based on the bossed-recessed shape and the excellent image quality for a long term.

FIG. 1 illustrates the printed matter producing apparatus 100 as a single-pass system that has an inkjet head-printable width greater than the width of the base material to which printing is performed and that is configured to perform scanning once. Instead, the printed matter producing apparatus of the present disclosure may be a multi-pass system that has a head width smaller than the width of the base material and that is provided with a driving mechanism (head unit or base material conveying) that enable scanning more than once.

FIG. 2 is a schematic view illustrating another example of the printed matter producing apparatus of the present disclosure.

The printed matter producing apparatus 101 illustrated in FIG. 2 is different from the printed matter producing apparatus 100 in that a curtain coater 30 is provided to apply the foamable layer forming liquid over the base material 19 and a head 31 for transparent layer forming liquid (clear ink) is provided to apply a transparent layer forming liquid (clear ink) by an inkjet method. Therefore, in the printed matter producing apparatus 101, the curtain coater 30 and the active energy ray irradiator 27 are an example of the foamable layer forming unit.

In addition to the operations performed by the printed matter producing apparatus 100, the printed matter producing apparatus 101 performs an operation of causing the active energy ray irradiator 17 to irradiate the base material 19 over which the clear ink is applied by the head 31 for transparent layer forming liquid (clear ink) with active energy rays at a predetermined irradiation condition to cure the clear ink and form a transparent layer. That is, in this example, the head 31 for transparent layer forming liquid (clear ink) and the active energy ray irradiator 17 are an example of the transparent layer forming unit.

Hence, the printed matter producing apparatus 101 can form a transparent layer over a printed matter. Therefore, the printed matter producing apparatus 101 can better improve the durability of a bossed-recessed shape and an image that are formed, and can produce a printed matter than can maintain an excellent design property based on a bossed-recessed shape and an excellent image quality for a long term.

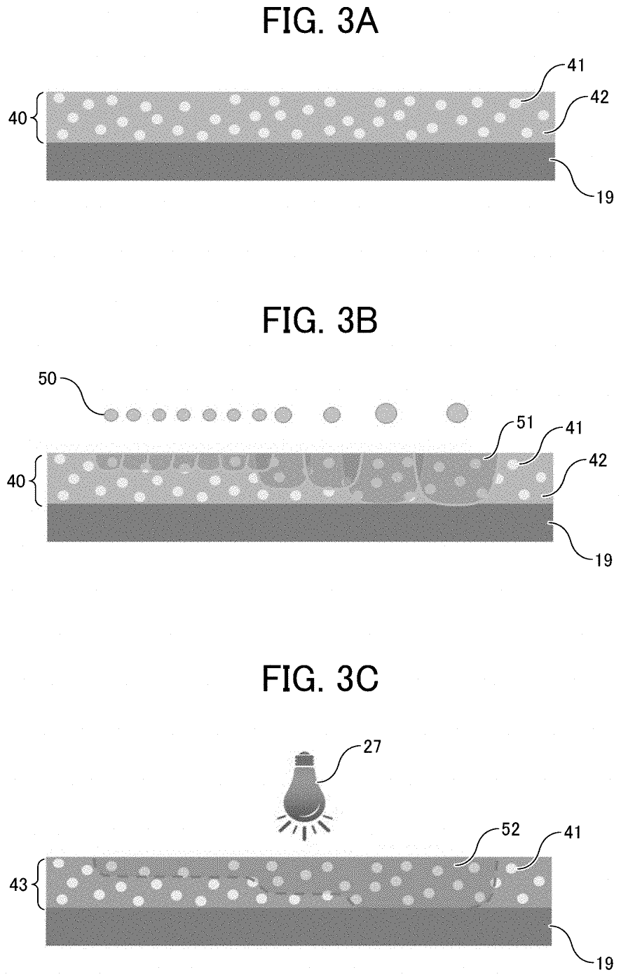

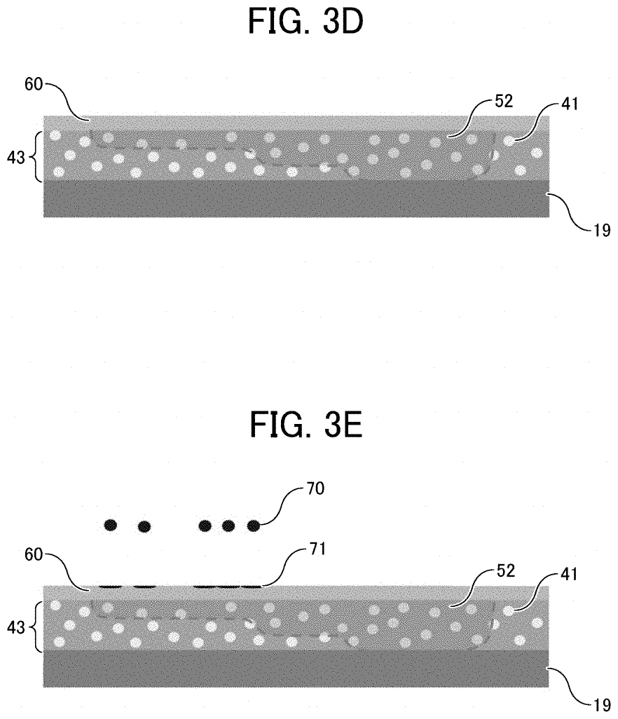

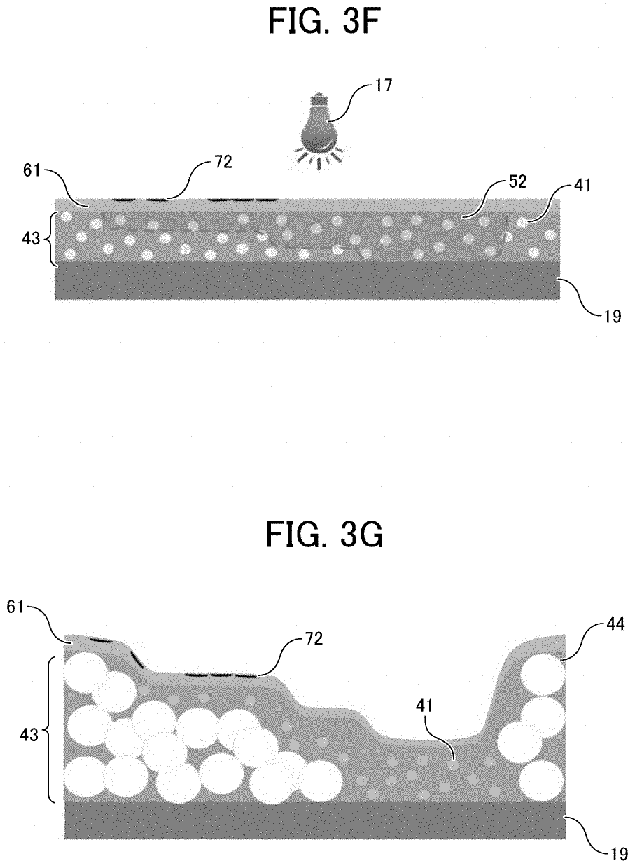

Next, an example of the flow of printed matter production according to the printed matter producing method of the present disclosure will be described below with reference to FIG. 3A to FIG. 3G.

As illustrated in FIG. 3A, the foamable layer forming liquid containing a foaming agent 41 and a liquid composition 42 is applied over the base material 19. As a result, a layer 40 of the foamable layer forming liquid is formed.

Next, as illustrated in FIG. 3B, a defoaming agent 50 containing a multifunctional monomer is applied and brought into contact with the layer 40 of the foamable layer forming liquid thus formed. As a result, the defoaming agent 50 permeates the layer 40 of the foamable layer forming liquid and forms defoaming agent-applied regions 51 in the layer 40 of the foamable layer forming liquid.

Next, as illustrated in FIG. 3C, the active energy ray irradiator 27 irradiates the layer 40 of the foamable layer forming liquid with active energy rays (for example, ultraviolet rays) to cure the layer 40 of the foamable layer forming liquid and form a foamable layer 43. When the layer 40 of the foamable layer forming liquid is cured by the active energy ray irradiator 27, the defoaming agent-applied regions 51 are also cured and become defoamed regions 52. The defoamed regions 52 are more firmly cured because the multifunctional monomer of the defoaming agent 50 is crosslinked three-dimensionally.

Next, as illustrated in FIG. 3D, the ink receiving layer forming liquid containing a polymerizable compound a is applied over the foamable layer 43, to form a layer 60 of the ink receiving layer forming liquid.

Next, as illustrated in FIG. 3E, an ink 70 containing a colorant and a polymerizable compound b is applied over the layer 60 of the ink receiving layer forming liquid, to form ink-applied regions 71.

Subsequently, as illustrated in FIG. 3F, the active energy ray irradiator 17 irradiates the layer 60 of the ink receiving layer forming liquid and the ink-applied regions 71 with active energy rays (for example, ultraviolet rays) to cure the layer 60 of the ink receiving layer forming liquid and the ink-applied regions 71, to form an ink receiving layer 61 and an image 72.

Next, as illustrated in FIG. 3G, the heater heats the foamable layer 43 to foam the foaming agent 41 and form the foamable layer 43 containing the foaming agent 44 that has foamed (volume-expanded), to produce a printed matter. Depending on, for example, the kind of the foaming agent, the foaming agent 44 foamed may have vanished. In this case, the reference numeral 44 may denote a cell (void).

Moreover, as illustrated in FIG. 3G, the foaming agent 41 has been suppressed from being foamed in the defoamed regions 52, because the defoamed regions 52 have been more firmly cured. Hence, it is possible to appropriately control the degree of foaming depending on, for example, the application amount of the defoaming agent 50.

Hence, the printed matter produced according to the example of the flow of printed matter production according to the printed matter producing method of the present disclosure illustrated in FIG. 3A to FIG. 3G has an excellent design property based on a bossed-recessed shape and an excellent image quality and can maintain the excellent design property based on the bossed-recessed shape and the excellent image quality for a long term.

### EXAMPLES

The present disclosure will be described below by way of Examples. The present disclosure should not be construed as being limited to these Examples.

### <Preparation of Foamable Layer Forming Liquid A1>

Azodicarboxylic acid amide (obtained from Eiwa Chemical Ind. Co., Ltd.) (3 parts by mass) serving as a foaming agent, zinc naphthenate (obtained from Tokyo Chemical Industry Co., Ltd.) (2 parts by mass) serving as a foaming accelerator, methoxypolyethylene glycol #400 acrylate (obtained from Shin-Nakamura Chemical Co., Ltd.) (80 parts by mass) serving as a polymerizable solvent (polymerizable compound), trimethylolpropane triacrylate (obtained from Tomoe Engineering Co., Ltd.) (10 parts by mass), and OMNIRAD TPO (obtained from IGM Resins B.V.) (5 parts by mass) serving as a polymerization initiator were stirred, to prepare a foamable layer forming liquid A1.

The static surface tension of the foamable layer forming liquid A1 at 25 degrees C. measured with a surface tensiometer DCAT (obtained from EKO Instruments Co., Ltd.) according to a plate method using a platinum plate at 25 degrees C. was 35 mN/m. The viscosity of the foamable layer forming liquid A1 at 25 degrees C. measured with a rheometer MCR302 (obtained from Anton-Paar GmbH) and CP50-1 (50 mm, 1° cone plate) at 25 degrees C. was 35 mPa·s.

### <Preparation of Ink Receiving Layer Forming Liquid A2>

2-Acryloyloxyethyl succinate (obtained from Shin-Nakamura Chemical Co., Ltd.) (94 parts by mass) serving as a polymerizable compound a, OMNIRAD TPO (obtained from IGN Resins B.V.) (5 parts by mass) serving as a polymerization initiator, and BYK-UV-3510 (obtained from BYK-Chemie GmbH) (1 part by mass) serving as a surfactant were stirred, to prepare an ink receiving layer forming liquid A2.

The static surface tension and the viscosity of the ink receiving layer forming liquid A2 at 25 degrees C. measured in the same manners as measuring the foamable layer forming liquid A1 were 20 mN/m and 190 mPa·s.

### <Preparation of Black Ink A-Bk>

Phenoxyethyl acrylate (obtained from Tokyo Chemical Industry Co., Ltd.) (25 parts by mass) serving as a polymerizable compound b, acryloylmorpholine (obtained from Tokyo Chemical Industry Co., Ltd.) (26 parts by mass), trimethylolpropaneethoxy triacrylate (obtained from Daicel-Allnex Ltd.) (35 parts by mass), OMNIRAD TPO (obtained from IGM Resins B.V.) (5 parts by mass) serving as a polymeriztion initiator, SOLSPERSE 32000 (obtained from Lubrizol Corporation) (2 parts by mass) serving as a surfactant/dispersant, and SPECIAL BLACK 350 (a black pigment, obtained from BASF Japan Ltd.) (7 parts by mass) serving as a colorant were stirred, to prepare a black ink A-Bk.

The static surface tension and the viscosity of the black ink A-Bk at 25 degrees C. measured in the same manners as measuring the foamable layer forming liquid A1 were 24 mN/m and 25 mPa·s.

### <Preparation of Magenta Ink A-M>

Phenoxyethyl acrylate (obtained from Tokyo Chemical Industry Co., Ltd.) (25 parts by mass) serving as a polymerizable compound b, acryloylmorpholine (obtained from Tokyo Chemical Industry Co., Ltd.) (26 parts by mass), trimethylolpropaneethoxy tricrylate (obtained from Daicel-Allnex Ltd.) (35 parts by mass), and OMNIRAD TPO (obtained from IGM Resins B.V.) (5 parts by mass) serving as a polymerization initiator, SOLSPERSE 32000 (obtained from Lubrizol Corporation) (2 parts by mass) serving as a surfactant/dispersant, and CINQUASIA MAGENTA RT-355-D (a magenta pigment, obtained from BASF Japan Ltd.) (7 parts by mass) serving as a colorant were stirred, to prepare a magenta ink A-M.

The static surface tension and the viscosity of the magenta ink A-M at 25 degrees C. measured in the same manners as measuring the foamable layer forming liquid A1 were 24 mN/m and 25 mPa·s.

### <Preparation of Cyan Ink A-C>

Phenoxyethyl acrylate (obtained from Tokyo Chemical Industry Co., Ltd.) (25 parts by mass) serving as a polymerizable compound b, acryloylmorpholine (obtained from Tokyo Chemical Industry Co., Ltd.) (26 parts by mass), trimethylolpropaneethoxy triacrylate (obtained from Daicel-Allnex Ltd.) (35 parts by mass), OMNIRAD TPO (obtained from IGM Resins B.V.) (5 parts by mass) serving as a polymerization initiator, SOLSPERSE 32000 (obtained from Lubrizol Corporation) (2 parts by mass) serving as a surfactant/dispersant, and IRGALITE BLUE GLVO (a cyan pigment, obtained from BASF Japan Ltd.) (40 parts by mass) as a colorant were stirred, to prepare a cyan ink A-C.

The static surface tension and the viscosity of the cyan ink A-C at 25 degrees C. measured in the same manners as measuring the foamable layer forming liquid A1 were 24 mN/m and 25 mPa·s.

### <Preparation of Yellow Ink A-Y>

Phenoxyethyl acrylate (obtained from Tokyo Chemical Industry Co., Ltd.) (25 parts by mass) serving as a polymerizable compound b, acryloylmorpholine (obtained from Tokyo Chemical Industry Co., Ltd.) (26 parts by mass), trimethylolpropaneethoxy triacrylate (obtained from Daicel-Allex Ltd.) (35 parts by mass), OMNIRAD TPO (obtained from IGM Resins B.V.) (5 parts by mass) serving as a polymerization initiator, SOLSPERSE 32000 (obtained from Lubrizol Corporation) (2 parts by mass) serving as a surfactant/dispersant, and NOVOPERM YELLOW H2G (a yellow pigment, obtained from Clariant Corporation) (40 parts by mass) serving as a colorant were stirred, to prepare a yellow ink A-Y

The static surface tension and the viscosity of the yellow ink A-Y at 25 degrees C. measured in the same manners as measuring the foamable layer forming liquid A1 were 24 mN/m and 25 mPa·s.

Next, using the printed matter producing apparatus 101 illustrated in FIG. 2, and the foamable layer forming liquid A1, the ink receiving layer forming liquid A2, the black ink A-Bk, the magenta ink A-M, the cyan ink A-C, and the yellow ink A-Y that were prepared, a printed matter 1 was obtained in the manner described below.

The curtain coater 30 (obtained from Cefla, a laboratory flow coater) applied the foamable layer forming liquid A1 with an average thickness of 100 micrometers over a MDF (a medium density fiberboard, obtained from Sumitomo Forestry Co., Ltd., N.P. wood) base material 19 having a thickness of 9 mm. Subsequently, the active energy ray irradiator 27 (obtained from Hamamatsu Photonics K.K., a linear irradiation-type UV-LED light source GJ-75) irradiated the surface of the base material with UV from a position apart by 10 mm from the surface of the base material, to cure the foamable layer forming liquid and form a foamable layer.

Next, the roller coater 28 (obtained from Matsuo Sangyo Co., Ltd., EASY PROOF) applied the ink receiving layer forming liquid A2 with an average thickness of 6 micrometers over the foamable layer.

Next, with the base material scanned at a speed of 15 m/min, a GENS head (MH5420, 150 npi×4 lines, obtained from Ricoh Industry Co., Ltd.) serving as the ink discharging head 16 heated the head 12 for black ink, the head 13 for cyan ink, the head 14 for magenta ink, and the head 15 for yellow ink to 40 degrees C. to discharge the black ink A-Bk, the magenta ink A-M, the cyan ink A-C, the yellow ink A-Y each in a liquid droplet amount of 7 pL at a liquid droplet speed of 7 m/s, to enable a solid image to be formed at 600 dpi×600 dpi for each color at a dot density of 25%. In the following description, the black ink A-Bk, the magenta ink A-M, the cyan ink A-C, and the yellow ink A-Y may be referred to collectively as “color inks”.

Next, the active energy ray irradiator 17 (obtained from Hamamatsu Photonics K.K., a linear irradiation-type UV-LED light source GJ-75) irradiated the surface of the base material with UV from a position apart by 10 mm from the surface of the base material, to cure the ink receiving layer forming liquid and the inks to form an ink receiving layer and an image. Here, the time from yellow ink discharging to curing was 6 seconds.

Next, the heater 18 performed foaming by heating. As the heater, a heater produced by combining LATEX BLOWER G SERIES obtained from Hitachi Industrial Equipment Systems Co., Ltd., a high hot air-generating electric heater XS-2 obtained from K.K. Kansai Dennetsu, and a high-blow nozzle 50AL obtained from K.K. Kansai Dennetsu and adjusting a wind speed from the nozzle tip to 30 m/sec and the nozzle tip temperature to 200 degrees C. was used. In the way described above, a printed matter 1 was obtained.

### Example 2

A printed matter 2 was obtained in the same manner as in Example 1 until application of the ink receiving layer forming liquid A2 with an average thickness of 6 micrometers, and subsequently in manner that unlike in Example 1, the heater 18 foamed the foamable layer by heating before the discharging head 16 discharged the color inks, and finally the active energy ray irradiator 17 cured the ink receiving layer forming liquid and the inks.

In Example 2, the order of the respective steps was changed by adjustment of the conveying order of the base material 19 and adjustment of the process timings of the respective steps in the printed matter producing apparatus 101 used in Example 1.

### Example 3

A printed matter 3 was obtained in the same manner as in Example 1 until formation of a foamable layer by curing of the foamable layer forming liquid A1, and subsequently in a manner that unlike in Example 1, the heater 18 foamed the foamable layer by heating before application of the ink receiving layer forming liquid A2 with an average thickness of 6 micrometers, then the discharging head 16 discharged the color inks, and finally the active energy ray irradiator 17 cured the ink receiving layer forming liquid and the inks. In Example 3, the order of the respective steps was changed in the same manner as in Example 2.

### Example 4

A printed matter 4 was obtained in the same manner as in Example 1, except that unlike in Example 1, the foamable layer forming liquid A1 was changed to a foamable layer forming liquid B1 described below.

### <Preparation of Foamable Layer Forming Liquid B1>

KUREHA MICROSPHERE (obtained from Kureha Corporation) (15 parts by mass) serving as a foaming agent, isobornyl acrylate (obtained from Tomoe Engineering Co., Ltd.) (40 parts by mass) serving as a polymerizable solvent (polymerizable compound), 2-acryloyloxyethyl phthalate (obtained from Shin-Nakamura Chemical Co., Ltd.) (40 parts by mass), and OMNIRAD TPO (obtained from IGM Resins B.V.) (5 parts by mass) serving as a polymerization initiator were stirred, to prepare a foamable layer forming liquid B1.

The static surface tension and the viscosity of the foamable layer forming liquid B1 at 25 degrees C. measured in the same manners as measuring the foamable layer forming liquid A1 were 33 mN/m and 130 mPa·s.

### Example 5

A printed matter 5 was obtained in the same manner as in Example 4, except that unlike in Example 4, before the discharging head 16 discharged the color inks, the head 31 for transparent layer forming liquid (clear ink) discharged a transparent layer forming liquid (clear ink) A-CL prepared in the manner described below in a liquid droplet amount of 7 pL at a liquid droplet speed of 7 m/s to enable a solid image to be formed at 600 dpi×600 dpi at a dot density of 100%, then the discharging head 16 discharged the color inks, and finally the active energy ray irradiator 17 cured the ink receiving layer forming liquid A2, the color inks, and the clear in A-CL to form an ink receiving layer, a transparent layer, and an image. That is, in Example 5, the printed matter 5 was produced in a manner that a base material, a foamable layer, an ink receiving layer, a transparent layer, and an image were formed in this order.

### <<Preparation of Clear Ink A-CL>>

Phenoxyethyl acrylate (obtained from Tokyo Chemical Industry Co., Ltd.) (25 parts by mass) serving as a polymerizable compound c, acryloylmorpholine (obtained from Tokyo Chemical Industry Co., Ltd.) (26 parts by mass), trimethylolpropaneethoxy triacrylate (obtained from Daicel-Allnex Ltd.) (42 parts by mass), OMNIRAD TPO (obtained from IGM Resins B.V.) (5 parts by mass) serving as a polymerization initiator, and SOLSPERSE 32000 (obtained from Lubrizol Corporation) (2 parts by mass) serving as a surfactant/dispersant were stirred, to prepare a clear ink A-CL.

The static surface tension and the viscosity of the clear ink A-CL at 25 degrees C. measured in the same manners as measuring the foamable layer forming liquid A1 were 24 mN/m and 20 mPa·s.

### Example 6

A printed matter 6 was obtained in the same manner as in Example 5, except that unlike in Example 5, after the discharging head 16 discharged the color inks, the clear ink A-CL was discharged, and finally the active energy ray irradiator 17 cured the ink receiving layer forming liquid A2, the color inks, and the clear ink A-CL to form an ink receiving layer, an image, and a transparent layer. That is, in Example 6, the printed matter 6 was produced in a manner that a base material, a foamable layer, an ink receiving layer, an image, a transparent layer were formed in this order.

### Example 7

A printed matter 7 was obtained in the same manner as in Example 4, except that unlike in Example 4, after application of the foamable layer forming liquid B1 with an average thickness of 100 micrometers over the base material 19, the head 11 discharged a defoaming agent I prepared in the manner described below in a liquid droplet amount of 30 pL at a liquid droplet speed of 7 m/s to apply a stripe-shaped defoaming pattern to the foamable layer at a dot density of 75 dpi in the head width direction and 600 dpi in the conveying direction. That is, in Example 7, a printed matter 7 having a stripe-shaped bossed-recessed shape and a solid image on the surface was produced.

### <<Preparation of Defoaming Agent I>>

1,6-Hexanediol diacrylate (obtained from Tomoe Engineering Co., Ltd.) (95 parts by mass) serving as a multifunctional monomer and OMNIRAD TPO (obtained from IGM Resins B.V.) (5 parts by mass) serving as a polymerization initiator were stirred, to prepare a defoaming agent I.

The static surface tension and the viscosity of the defoaming agent I at 25 degrees C. measured in the same manners as measuring the foamable layer forming liquid A1 were 24 mN/m and 20 mPa·s.

### Example 8

A printed matter 8 was produced in the same manner as in Example 7, except that unlike in Example 7, EC300/30/30MA obtained from Iwasaki Electric Co., Ltd. was used as the active energy ray irradiators 17 and 27 and a compressor-added N₂ gas generator (MAXI-FLOW 30, obtained from Inhouse Gas Co., Ltd.) coupled in an inert gas blanket at a pressure of 0.2 MPa·s for flowing N₂ at a flow rate of from 2 L/min through 10 L/min and setting the oxygen concentration to 500 ppm or lower was used as an inert gas source, to irradiate and cure the foamable layer forming liquid B1, an ink receiving layer, and an image with active energy rays at an accelerating voltage of 30 kV and at a dose of 30 kGy as irradiation conditions.

### Example 9

A printed matter 9 was produced in the same manner as in Example 1, except that unlike in Example 1, before application of the foamable layer forming liquid A1 over the base material 19, TEC-4AX (obtained from Kasuga Denki, Inc.) applied a corona discharge treatment to the base material 19 at a gap of 1 mm between an electrode and the surface of the base material at 2 m/min at 100 W, to reform the surface of the base material 19.

### Example 10

A printed matter 10 was produced in the same manner as in Example 1, except that unlike in Example 1, before application of the ink receiving layer forming liquid A2 over the foamable layer, TEC-4AX (obtained from Kasuga Denki, Inc.) applied a corona discharge treatment to the foamable layer at a gap of 1 mm between an electrode and the surface of the base material at 2 m/min at 100 W, to reform the surface of the foamable layer.

### Example 11

A printed matter 11 was obtained in the same manner as in Example 1, except that unlike in Example 1, before application of the foamable layer forming liquid A1, the roller coater applied an intermediate layer forming liquid 1 prepared in the manner described below with a thickness of 5 micrometers over a MDF base material 19, and then the active energy ray irradiator (obtained from Hamamatsu Photonics K.K., a linear irradiation-type UV-LED light source GJ-75) cured the intermediate layer forming liquid 1.

### <Preparation of Adhesive Layer Forming Liquid 1>

1,4-Cyclohexanedimethanol monoacrylate (obtained from Mitsubishi Chemical Corporation) (10 parts by mass) serving as a polymerizable compound e, 2-acryloyloxyethyl phthalate (obtained from Shin-Nakamura Chemical Co., Ltd.) (85 parts by mass), and OMNIRAD TPO (obtained from IGM Resins B.V.) (5 parts by mass) serving as a polymerization initiator were stirred, to prepare an adhesive layer forming liquid 1.

The static surface tension of the adhesive layer forming liquid 1 at 25 degrees C. was 40 mN/m and the viscosity of the adhesive layer forming liquid 1 at 25 degrees C. was 7,000 mPa·s.

The static surface tension at 25 degrees C. was measured with an automatic surface tensiometer DY-300 obtained from Kyowa Interface Science, Inc according to a plate method. The viscosity at 25 degrees C. was measured with a rheometer MCR301 obtained from Anton Paar GmbH and a cone plate CP25-1 at a shear rate of 10/s at 25 degrees C. In the following description, static surface tension and viscosity were measured in the same manner.

### Example 12

A printed matter 12 was obtained in the same manner as in Example 11, except that unlike in Example 11, the adhesive layer forming liquid 1 was changed to an adhesive layer forming liquid 2 prepared in the manner described below.

### <Preparation of Adhesive Layer Forming Liquid 2>

2-Acrylamide-2-methylpropane sulfonic acid (obtained from Tokyo Chemical Industry Co., Ltd.) (10 parts by mass) serving as a polymerizable compound e, 2-acryloyloxyethyl phthalate (obtained from Shin-Nakamura Chemical Co., Ltd.) (85 parts by mass), and OMNIRAD TPO (obtained from IGM Resins B.V.) (5 parts by mass) serving as a polymerization initiator were stirred, to prepare an adhesive layer forming liquid 2.

The static surface tension of the adhesive layer forming liquid 2 at 25 degrees C. was 40 mN/m and the viscosity of the adhesive layer forming liquid 2 at 25 degrees C. was 6,000 mPa·s.

### Example 13

A printed matter 13 was obtained in the same manner as in Example 11, except that unlike in Example 11, the adhesive layer forming liquid 1 was changed to an adhesive forming liquid 3, which was BONCOAT W-26 (obtained from DIC Corporation) serving as a dispersible resin, and the adhesive layer forming liquid 3 was dried in an oven of 100 degrees C. for 1 minute after application thereof.

### Example 14

A printed matter 14 was obtained in the same manner as in Example 11, except that unlike in Example 11, the adhesive layer forming liquid 1 was changed to an adhesive layer forming liquid 4, which was FINETACK CT-5020 (obtained from DIC Corporation) serving as a dissolved resin, and the adhesive layer forming liquid 4 was dried in an oven of 100 degrees C. for 1 minute after application thereof.

### Example 15

A printed matter 15 was obtained in the same manner as in Example 11, except that unlike in Example 11, the adhesive layer forming liquid 1 was changed to an adhesive layer forming liquid 5 prepared in the manner described below.

### <Preparation of Intermediate Layer Forming Liquid 5>

BONCOAT W-26 (obtained from DIC Corporation) (90 parts by mass) serving as a dispersible resin and ORGANOSILICASOL IPA-ST-UP (obtained from Nissan Chemical Corporation) (10 parts by mass) serving as solid particles were stirred, to prepare an intermediate layer forming liquid 5.

### Example 16

A printed matter 16 was obtained in the same manner as in Example 11, except that unlike in Example 11, the adhesive layer forming liquid 1 was changed to an adhesive layer forming liquid 6 prepared in the manner described below.

### <Preparation of Intermediate Layer Forming Liquid 6>

FINETACK CT-5020 (obtained from DIC Corporation) (90 parts by mass) serving as a dissolved resin and ORGANOSILICASOL MEK-ST-UP (obtained from Nissan Chemical Corporation) (10 parts by mass) serving as solid particles were stirred, to prepare an adhesive layer forming liquid 6.

### Example 17

### <Preparation of Filler-Containing Layer Forming Liquid 1>

A printed matter 17 including a filler-containing layer was obtained in a manner that after an ink receiving layer and an image were formed in Example 1, a roller coater applied a filler-containing layer forming liquid 1 prepared in the manner described below with an average thickness of 20 micrometers over the image, the active energy ray irradiator 27 irradiated the base material 19 with ultraviolet rays from an irradiation distance of 10 mm to cure the filler-containing layer forming liquid 1, and finally the heater 18 foamed the foamable layer.

### <Preparation of Filler-Containing Layer Forming Liquid 1>

2-Acryloyloxyethyl succinate (obtained from Shin-Nakamura Chemical Co., Ltd.) (84.9 parts by mass) serving as a polymerizable compound d, OMNIRAD TPO (obtained from IGM Resins B.V.) (5 parts by mass) serving as an initiator, BYK-UV-3510 (obtained from BYK-Chemie GmbH) (0.1 parts by mass) serving as a surfactant, and silica (with an average primary particle diameter of 0.6 micrometers, and a refractive index of 1.46) (10 parts by mass) serving as a filler were mixed and stirred, to prepare a filler-containing layer forming liquid 1.

The static surface tension of the filler-containing layer forming liquid at 25 degrees C. was 29 mN/m and the viscosity of the filler-containing layer forming liquid at 25 degrees c. was 400 mPa·s.

### Comparative Example 1

A printed matter 18 was produced in the same manner as in Example 4, except that unlike in Example 4, application and curing of the ink receiving layer forming liquid A2 were skipped in order not to form an ink receiving layer.

### Comparative Example 2

A printed matter 19 was produced in the same manner as in Example 4, except that unlike in Example 4, application and curing of the foamable layer forming liquid B1 were skipped in order not to form a foamable layer.

### EVALUATION

Next, the image qualities (image quality and durability) and the design property of the printed matters 1 to 19 of Examples 1 to 17 and Comparative Examples 1 and 2 obtained were evaluated in the manners described below. The evaluation results are presented in Table 1.

### <<Evaluation of Image Quality>>

Color developability of the solid image formed with the color inks was visually observed, and evaluated according to the criteria described below. The ratings B and A are non-problematic levels for practical use.

### [Evaluation Criteria for Color Developability]

A: Unwanted pattern due to color developing density unevenness was not observed in the in-plane direction of the solid image.

B: Unwanted pattern due to color developing density unevenness was observed in the in-plane direction of the solid image but was not conspicuous.

C: Unwanted pattern due to color developing density unevenness was observed in the in-plane direction of the solid image.

Next, the surface of the printed matter having the printed image was rubbed with nonwoven cloth a hundred times and then scratched with nails three times, to evaluate durability of the solid image formed with the color inks according to the criteria described below. The ratings B and A are non-problematic levels for practical use.

### [Evaluation Criteria for Durability]

A: Neither scars on the image due to rubbing nor peeling of the image from the base material were observed.

B: Scars on the image due to rubbing were observed, but peeling of the image from the base material was not observed.

C: Scars on the image due to rubbing were observed, and peeling of the image from the base material was also observed.

### <<Evaluation of Design Property>>

The design property of the printed matter produced was evaluated according to the criteria described below. The evaluation criteria for Examples 1 to 6 and 9 to 17 having no stripe-shaped bossed-recessed shape are different from the evaluation criteria for Examples 7 and 8 and Comparative Examples 1 and 2 having a stripe-shaped bossed-recessed shape, as presented below. The ratings B and A are non-problematic levels for practical use.

### [Evaluation Criteria for Design Property of Examples 1 to 6 and 9 to 17]

A: The level difference between a printed portion (a portion at which at least the foamable layer, the ink receiving layer, and the image were formed over the base material) and a non-printed portion (the base material only) of the printed matter was 400 micrometers or greater.

B: The level difference between a printed portion and a non-printed portion of the printed matter was 150 micrometers or greater but less than 400 micrometers.

C: The level difference between a printed portion and a non-printed portion of the printed matter was less than 150 micrometers.

In the evaluation of the design property of Examples 1 to 6 and 9 to 17, the level difference between a printed portion and a non-printed portion was measured by shape measurement with a laser microscope VK-X100 (obtained from Keyence Corporation).

### [Evaluation Criteria for Design Property of Examples 7 and 8 and Comparative Examples 1 and 2]

A: Level difference in the stripe-shaped bossed-recessed shape was recognizable only by visual observation.

B: Level difference in the stripe-shaped bossed-recessed shape was not recognizable by visual observation but was recognizable by touch.

C: Level difference in the stripe-shaped bossed-recessed shape was not recognizable even by touch.

TABLE 1

| | Color | | Design |
|---|---|---|---|
| | developability | Durability | property |
| Ex. 1 | A | B | B |
| Ex. 2 | B | B | B |
| Ex. 3 | B | B | B |
| Ex. 4 | A | B | A |
| Ex. 5 | A | B | A |
| Ex. 6 | A | A | A |
| Ex. 7 | A | B | A |
| Ex. 8 | A | A | A |
| Ex. 9 | A | A | B |
| Ex. 10 | A | A | B |
| Ex. 11 | A | B | B |
| Ex. 12 | A | B | B |
| Ex. 13 | A | B | B |
| Ex. 14 | A | B | B |
| Ex. 15 | A | B | B |
| Ex. 16 | A | B | B |
| Ex. 17 | A | A | B |
| Comp. Ex. 1 | C | C | A |
| Comp. Ex. 2 | A | B | C |

From the results presented in Table 1, it was revealed that the printed matters 1 to 17 of Examples 1 to 17 were superior to the printed matters 18 and 19 of Comparative Examples 1 and 2 in image qualities (image quality and durability) and design property.

Particularly, the printed matter 17 including a filler-containing layer had an excellent abrasion resistance.

As described above, the printed matter producing method of the present disclosure includes a foamable layer forming step of forming a foamable layer containing a foaming agent, an ink receiving layer forming step of forming an ink receiving layer containing a polymer of a polymerizable compound a over the foamable layer, an image forming step of applying an ink containing a colorant and a polymerizable compound b over the ink receiving layer to form an image, and a foaming step of heating the foamable layer to foam the foamable layer.

Hence, the printed matter producing method of the present disclosure can produce a printed matter that has an excellent design property based on a bossed-recessed shape and an excellent image quality and can maintain the excellent design property based on the bossed-recessed shape and the excellent image quality for a long term.

Aspects of the present disclosure are, for example, as follows.

<1> A printed matter producing method including:

forming a foamable layer containing a foaming agent;

forming an ink receiving layer containing a polymer of a polymerizable compound a over the foamable layer;

applying an ink containing a colorant and a polymerizable compound b over the ink receiving layer to form an image; and

heating the foamable layer to foam the foamable layer.

<2> The printed matter producing method according to <1>,

wherein in the forming a foamable layer, the foamable layer is formed by application of a foamable layer forming liquid containing the foaming agent over a base material and subsequent curing of the foamable layer forming liquid.

<3> The printed matter producing method according to <1> or <2>,

wherein in the forming an ink receiving layer, the ink receiving layer is formed by application of an ink receiving layer forming liquid containing the polymerizable compound a over the foamable layer and subsequent curing of the ink receiving layer forming liquid.

<4> The printed matter producing method according to <3>,

wherein in the applying an ink, the image is formed by application of the ink over the ink receiving layer and subsequent curing of the ink.

<5> The printed matter producing method according to <4>,

wherein curing of the ink receiving layer forming liquid in the forming an ink receiving layer and curing of the ink in the applying an ink are performed collectively.

<6> The printed matter producing method according to any one of <1> to <5>,

wherein in the applying an ink, the ink is applied over the ink receiving layer by an inkjet method.

<7> The printed matter producing method according to any one of <1> to <6>,

wherein the heating the foamable layer is performed after the applying an ink.

<8> The printed matter producing method according to any one of <1> to <7>,

wherein the foaming agent is a thermally expansible microcapsule.

<9> The printed matter producing method according to any one of <1> to <8>, further including

forming a transparent layer containing a polymer of a polymerizable compound c over at least one of the ink receiving layer and the image.

<10> The printed matter producing method according to <9>,

wherein in the forming a transparent layer, the transparent layer is formed over at least the image.

<11> The printed matter producing method according to any one of <1> to <10>, further including

applying a defoaming agent containing a multifunctional monomer to a predetermined region of the foamable layer to bring the defoaming agent into contact with the predetermined region.

<12> The printed matter producing method according to <11>,

wherein in the applying a defoaming agent, the defoaming agent is applied by an inkjet method.

<13> The printed matter producing method according to any one of <1> to <12>, further including before the forming a foamable layer,

applying a corona discharge treatment to a base material over which the foamable layer is to be formed, to reform a surface of the base material.

<14> The printed matter producing method according to any one of <1> to <13>, further including after the forming a foamable layer,

applying a corona discharge treatment to the foamable layer to reform a surface of the foamable layer.

<15> The printed matter producing method according to any one of <1> to <14>, further including

forming a filler-containing layer containing a filler over at least one of the ink receiving layer and the image.

<16> The printed matter producing method according to <15>,

wherein in the forming a filler-containing layer, the filler-containing layer is formed by application of a filler-containing layer forming liquid containing the filler and a polymerizable compound d over at least one of the ink receiving layer and the image and subsequent curing of the filler-containing layer forming liquid.

<17> The printed matter producing method according to any one of <1> to <16>, further including before the forming a foamable layer

forming an adhesive layer for bonding a base material and the foamable layer with each other over the base material.

<18> The printed matter producing method according to <17>,

wherein in the forming an adhesive layer, the adhesive layer is formed by application of an adhesive layer forming liquid for forming the adhesive layer over the base material and subsequent curing of the adhesive layer forming liquid, and

wherein the adhesive layer forming liquid contains at least one of a polymerizable compound e, a dispersible resin, and a dissolved resin.

<19> A printed matter producing apparatus (100; 101) including:

a foamable layer forming unit (10; 27; 30) configured to form a foamable layer containing a foaming agent;

an ink receiving layer forming unit (28; 17) configured to form an ink receiving layer containing a polymer of a polymerizable compound a over the foamable layer;

an image forming unit (16; 17) configured to apply an ink containing a colorant and a polymerizable compound b over the ink receiving layer to form an image; and

a foaming unit (18) configured to heat the foamable layer to foam the foamable layer.

<20> A printed matter including:

a cell-containing layer (43) containing cells;

an ink receiving layer (61) positioned over the cell-containing layer (43) and containing a polymer A; and

an image (72) positioned over the ink receiving layer (61) and formed of a cured product of an ink containing a colorant and a polymer B.

The printed matter producing method according to any one of <1> to <18>, the printed matter producing apparatus according to <19>, and the printed matter according to

<20> can solve the various problems in the related art and achieve the object of the preset disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A printed matter producing method comprising:
forming a foamable layer containing a foaming agent;
forming an ink receiving layer containing a polymer of a polymerizable compound a over the foamable layer;
applying an ink containing a colorant and a polymerizable compound b over the ink receiving layer to form an image; and
heating the foamable layer to foam the foamable layer.

2. The printed matter producing method according to claim 1,
wherein in the forming a foamable layer, the foamable layer is formed by application of a foamable layer forming liquid containing the foaming agent over a base material and subsequent curing of the foamable layer forming liquid.

3. The printed matter producing method according to claim 1,
wherein in the forming an ink receiving layer, the ink receiving layer is formed by application of an ink receiving layer forming liquid containing the polymerizable compound a over the foamable layer and subsequent curing of the ink receiving layer forming liquid.

4. The printed matter producing method according to claim 3,
wherein in the applying an ink, the image is formed by application of the ink over the ink receiving layer and subsequent curing of the ink.

5. The printed matter producing method according to claim 4,
wherein curing of the ink receiving layer forming liquid in the forming an ink receiving layer and curing of the ink in the applying an ink are performed collectively.

6. The printed matter producing method according to claim 1,
wherein in the applying an ink, the ink is applied over the ink receiving layer by an inkjet method.

7. The printed matter producing method according to claim 1,
wherein the heating the foamable layer is performed after the applying an ink.

8. The printed matter producing method according to claim 1,
wherein the foaming agent is a thermally expansible microcapsule.

9. The printed matter producing method according to claim 1, further comprising
forming a transparent layer containing a polymer of a polymerizable compound c over at least one of the ink receiving layer and the image.

10. The printed matter producing method according to claim 9,
wherein in the forming a transparent layer, the transparent layer is formed over at least the image.

11. The printed matter producing method according to claim 1, further comprising
applying a defoaming agent containing a multifunctional monomer to a predetermined region of the foamable layer to bring the defoaming agent into contact with the predetermined region.

12. The printed matter producing method according to claim 11,
wherein in the applying a defoaming agent, the defoaming agent is applied by an inkjet method.

13. The printed matter producing method according to claim 1, further comprising before the forming a foamable layer,
applying a corona discharge treatment to a base material over which the foamable layer is to be formed, to reform a surface of the base material.

14. The printed matter producing method according to claim 1, further comprising after the forming a foamable layer,
applying a corona discharge treatment to the foamable layer to reform a surface of the foamable layer.

15. The printed matter producing method according to claim 1, further comprising
forming a filler-containing layer containing a filler over at least one of the ink receiving layer and the image.

16. The printed matter producing method according to claim 15,
wherein in the forming a filler-containing layer, the filler-containing layer is formed by application of a filler-containing layer forming liquid containing the filler and a polymerizable compound d over at least one of the ink receiving layer and the image and subsequent curing of the filler-containing layer forming liquid.

17. The printed matter producing method according to claim 1, further comprising before the forming a foamable layer
forming an adhesive layer for bonding a base material and the foamable layer with each other over the base material.

18. The printed matter producing method according to claim 17,
wherein in the forming an adhesive layer, the adhesive layer is formed by application of an adhesive layer forming liquid for forming the adhesive layer over the base material and subsequent curing of the adhesive layer forming liquid, and
wherein the adhesive layer forming liquid contains at least one of a polymerizable compound e, a dispersible resin, and a dissolved resin.

19. A printed matter producing apparatus comprising:
a foamable layer forming unit configured to form a foamable layer containing a foaming agent;
an ink receiving layer forming unit configured to form an ink receiving layer containing a polymer of a polymerizable compound a over the foamable layer;
an image forming unit configured to apply an ink containing a colorant and a polymerizable compound b over the ink receiving layer to form an image; and
a foaming unit configured to heat the foamable layer to foam the foamable layer.

20. A printed matter comprising:
a cell-containing layer containing cells;
an ink receiving layer positioned over the cell-containing layer and containing a polymer A; and
an image positioned over the ink receiving layer and formed of a cured product of an ink containing a colorant and a polymer B.
